(19) United States
(12) Patent Application Publication
(10) Pub. No.: US 2024/0333442 A1
(43) Pub. Date: Oct. 3, 2024

(54) METHOD AND APPARATUS FOR SUPPORTING SIDELINK CARRIER AGGREGATION

(71) Applicant: ELECTRONICS AND TELECOMMUNICATIONS RESEARCH INSTITUTE, Daejeon (KR)

(72) Inventors: Jung Hoon LEE, Daejeon (KR); Cheul Soon KIM, Daejeon (KR); Sung Hyun MOON, Daejeon (KR)

(73) Assignee: ELECTRONICS AND TELECOMMUNICATIONS RESEARCH INSTITUTE, Daejeon (KR)

(21) Appl. No.: 18/620,695

(22) Filed: Mar. 28, 2024

(30) Foreign Application Priority Data
Mar. 29, 2023 (KR) 10-2023-0041149
Jun. 30, 2023 (KR) 10-2023-0084811
Aug. 11, 2023 (KR) 10-2023-0105552
Sep. 26, 2023 (KR) 10-2023-0128948
Mar. 25, 2024 (KR) 10-2024-0040650

(51) Int. Cl. H04L 5/00; H04L 1/1812; H04W 72/40

(52) U.S. Cl. CPC H04L 5/001; H04L 1/1812; H04W 72/40

(57) ABSTRACT

The method and apparatus for supporting sidelink carrier aggregation are disclosed. A method of a first terminal may comprise: aligning sidelink (SL) resources in a first component carrier (CC) and a second CC; and performing SL communication with a second terminal using the SL resources aligned within the first CC and the second CC.

### CROSS-REFERENCE TO RELATED APPLICATIONS

This application claims priority to Korean Patent Applications No. 10-2023-0041149, filed on Mar. 29, 2023, No. 10-2023-0084811, filed on Jun. 30, 2023, No. 10-2023-0105552, filed on Aug. 11, 2023, No. 10-2023-0128948, filed on Sep. 26, 2023, and No. 10-2024-0040650, filed on Mar. 25, 2024, with the Korean Intellectual Property Office (KIPO), the entire contents of which are hereby incorporated by reference.

### BACKGROUND

### 1. Technical Field

The present disclosure relates to a sidelink communication technique, and more particularly, to a sidelink communication technique using aggregated carriers.

### 2. Related Art

The communication system (e.g. a new radio (NR) communication system) using a higher frequency band (e.g. a frequency band of 6 GHz or above) than a frequency band (e.g. a frequency band of 6 GHz or below) of the long term evolution (LTE) communication system (or, LTE-A communication system) is being considered for processing of soaring wireless data. The NR system may support not only a frequency band of 6 GHz or below, but also a frequency band of 6 GHz or above, and may support various communication services and scenarios compared to the LTE system. In addition, requirements of the NR system may include enhanced Mobile BroadBand (eMBB), Ultra Reliable Low Latency Communication (URLLC), and Massive Machine Type Communication (mMTC).

The NR communication system can support sidelink (SL) communication, and SL communication may be performed using one carrier. To improve the performance of SL communication, it may be considered to use multiple carriers. In this case, methods to support

SL communication using aggregated carriers (e.g. multiple carriers) will be needed.

### SUMMARY

The present disclosure for solving the above-described problems is directed to providing a method and an apparatus for supporting carrier aggregation in sidelink communication.

A method of a first terminal, according to exemplary embodiments of the present disclosure for achieving the above-described objection, may comprise: aligning sidelink (SL) resources in a first component carrier (CC) and a second CC; and performing SL communication with a second terminal using the SL resources aligned within the first CC and the second CC.

The SL resources may include at least one of a start symbol for the SL communication, a length of resource for the SL communication, a length of a cyclic prefix (CP), a physical sidelink feedback channel (PSFCH) periodicity, or a sidelink(S)-synchronization signal block (SSB) periodicity.

The method may further comprise: receiving SL resource configuration information from a base station, wherein the SL resources are aligned in the first CC and the second CC based on the SL resource configuration information.

The method may further comprise: transmitting SL resource configuration information used for alignment of the SL resources to the second terminal.

The performing of the SL communication may include: transmitting an S-SSB in a synchronization(S)-CC among the first CC and the second CC, wherein the S-SSB may not be transmitted in a remaining CC excluding the S-CC among the first CC and the second CC, and synchronization in the S-CC and the remaining CC may be acquired based on the S-SSB.

The S-CC may be indicated by signaling of a base station, the S-CC may be configured as a CC with a lowest index or a highest index among the first CC and the second CC, or the S-CC may be configured as a CC in which an S-SSB associated with a synchronization reference with a highest priority among the first CC and the second CC is transmitted.

The performing of the SL communication may include: performing initial transmission of SL data in one CC among the first CC and the second CC; and receiving hybrid automatic repeat request (HARQ) feedback information for the SL data from the second terminal in the one CC, wherein the initial transmission and reception of the HARQ feedback information may be performed in a same CC.

The performing of the SL communication may include: in response to the HARQ feedback information indicating a negative acknowledgment (NACK), performing retransmission of the SL data in the one CC, wherein the initial transmission, reception of the HARQ feedback information, and the retransmission may be performed in a same CC.

The SL communication may include PSFCH transmission, and a number of PSFCH transmissions performed in the first CC and the second CC may be determined considering at least one of a maximum transmission power or a maximum number of the PSFCH transmissions.

The performing of the SL communication may include: when an SL transmission operation occurs in the first CC and an SL reception operation occurs in the second CC or when an SL transmission operation and an SL reception operation occur in one CC among the first CC and the second CC, selecting one operation among the SL transmission operation and the SL reception operation based on priorities; and performing the selected one operation.

A first terminal, according to exemplary embodiments of the present disclosure for achieving the above-described objection, may comprise at least one processor, and the at least one processor may cause the first terminal to perform: aligning sidelink (SL) resources in a first component carrier (CC) and a second CC; and performing SL communication with a second terminal using the SL resources aligned within the first CC and the second CC.

The SL resources may include at least one of a start symbol for the SL communication, a length of resource for the SL communication, a length of a cyclic prefix (CP), a physical sidelink feedback channel (PSFCH) periodicity, or a sidelink(S)-synchronization signal block (SSB) periodicity.

The at least one processor may further cause the first terminal to perform: receiving SL resource configuration information from a base station, wherein the SL resources may be aligned in the first CC and the second CC based on the SL resource configuration information.

The at least one processor may further cause the first terminal to perform: transmitting SL resource configuration information used for alignment of the SL resources to the second terminal.

In the performing of the SL communication, the at least one processor may further cause the first terminal to perform: transmitting an S-SSB in a synchronization(S)-CC among the first CC and the second CC, wherein the S-SSB may not be transmitted in a remaining CC excluding the S-CC among the first CC and the second CC, and synchronization in the S-CC and the remaining CC may be acquired based on the S-SSB.

The S-CC may be indicated by signaling of a base station, the S-CC may be configured as a CC with a lowest index or a highest index among the first CC and the second CC, or the S-CC may be configured as a CC in which an S-SSB associated with a synchronization reference with a highest priority among the first CC and the second CC is transmitted.

In the performing of the SL communication, the at least one processor may further cause the first terminal to perform: performing initial transmission of SL data in one CC among the first CC and the second CC; and receiving hybrid automatic repeat request (HARQ) feedback information for the SL data from the second terminal in the one CC, wherein the initial transmission and reception of the HARQ feedback information may be performed in a same CC.

In the performing of the SL communication, the at least one processor further causes the first terminal to perform: in response to the HARQ feedback information indicating a negative acknowledgment (NACK), performing retransmission of the SL data in the one CC, wherein the initial transmission, reception of the HARQ feedback information, and the retransmission may be performed in a same CC.

The SL communication may include PSFCH transmission, and a number of PSFCH transmissions performed in the first CC and the second CC may be determined considering at least one of a maximum transmission power or a maximum number of the PSFCH transmissions.

In the performing of the SL communication, the at least one processor may further cause the first terminal to perform: when an SL transmission operation occurs in the first CC and an SL reception operation occurs in the second CC or when an SL transmission operation and an SL reception operation occur in one CC among the first CC and the second CC, selecting one operation among the SL transmission operation and the SL reception operation based on priorities; and performing the selected one operation.

According to the present disclosure, a first terminal can align SL resource configurations in a plurality of CCs, and perform SL communication with a second terminal using the aligned SL resources in the plurality of CCs. The first terminal can transmit sidelink (S)-synchronization signal block(s) (SSB(s)) in a synchronization(S)-CC among the plurality of CCs. Synchronization in the plurality of CCs may be acquired based on the S-SSB(s) transmitted in the S-CC. SL communication can be performed using the plurality of CCs, leading to improvement of the performance of SL communication.

### BRIEF DESCRIPTION OF DRAWINGS

FIG. 1 is a conceptual diagram illustrating exemplary embodiments of a communication system.

FIG. 2 is a block diagram illustrating exemplary embodiments of a communication node constituting a communication system.

FIG. 3 is a conceptual diagram illustrating exemplary embodiments of a type 1 frame.

FIG. 4 is a conceptual diagram illustrating exemplary embodiments of a type 2 frame.

FIG. 5 is a conceptual diagram illustrating exemplary embodiments of a first transmission method of SS/PBCH blocks in a communication system.

FIG. 6 is a conceptual diagram illustrating exemplary embodiments of an SS/PBCH block in a communication system.

FIG. 7 is a conceptual diagram illustrating exemplary embodiments of a second transmission method of SS/PBCH blocks in a communication system.

FIG. 8 is a conceptual diagram illustrating exemplary embodiments of SSB burst configuration.

FIG. 9A is a conceptual diagram illustrating an RMSI CORESET mapping pattern #1 in a communication system.

FIG. 9B is a conceptual diagram illustrating an RMSI CORESET mapping pattern #2 in a communication system.

FIG. 9C is a conceptual diagram illustrating an RMSI CORESET mapping pattern #3 in a communication system.

FIG. 10 is a conceptual diagram illustrating exemplary embodiments of configuration of a slot in which a PSFCH is configured.

FIG. 11 is a conceptual diagram illustrating exemplary embodiments of a PSFCH for ACK/NACK transmission.

FIG. 12 is a conceptual diagram illustrating exemplary embodiments of a method for multiplexing a control channel and a data channel in sidelink communication.

FIG. 13 is a conceptual diagram illustrating exemplary embodiments of a resource selection operation.

FIG. 14 is a conceptual diagram illustrating exemplary embodiments of a resource reselection operation.

FIG. 15 is a conceptual diagram illustrating exemplary embodiments of a resource selection operation in an SL CA environment.

FIG. 16 is a conceptual diagram illustrating exemplary embodiments of a resource selection operation in an SL CA environment.

FIG. 17A is a conceptual diagram illustrating exemplary embodiments of a first synchronization method according to S-CC configuration in an SL CA environment.

FIG. 17B is a conceptual diagram illustrating exemplary embodiments of a second synchronization method according to S-CC configuration in an SL CA environment.

### DETAILED DESCRIPTION OF THE EMBODIMENTS

Exemplary embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In exemplary embodiments of the present disclosure, “(re)transmission” may mean “transmission”, “retransmission”, or “transmission and retransmission”, “(re)configuration” may mean “configuration”, “reconfiguration”, or “configuration and reconfiguration”, “(re)connection” may mean “connection”, “reconnection”, or “connection and reconnection”, and “(re)access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e. “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system may be the 4G communication system (e.g. Long-Term Evolution (LTE) communication system or LTE-A communication system), the 5G communication system (e.g. New Radio (NR) communication system), the sixth generation (6G) communication system, or the like. The 4G communication system may support communications in a frequency band of 6 GHz or below, and the 5G communication system may support communications in a frequency band of 6 GHz or above as well as the frequency band of 6 GHz or below. The communication system to which the exemplary embodiments according to the present disclosure are applied is not limited to the contents described below, and the exemplary embodiments according to the present disclosure may be applied to various communication systems. Here, the communication system may be used in the same sense as a communication network, ‘LTE’ may refer to ‘4G communication system’, ‘LTE communication system’, or ‘LTE-A communication system’, and ‘NR’ may refer to ‘5G communication system’ or ‘NR communication system’.

In exemplary embodiments, “an operation (e.g. transmission operation) is configured” may mean that “configuration information (e.g. information element(s) or parameter(s)) for the operation and/or information indicating to perform the operation is signaled”. “Information element(s) (e.g. parameter(s)) are configured” may mean that “corresponding information element(s) are signaled”. The signaling may be at least one of system information (SI) signaling (e.g. transmission of system information block (SIB) and/or master information block (MIB)), RRC signaling (e.g. transmission of RRC parameters and/or higher layer parameters), MAC control element (CE) signaling, or PHY signaling (e.g. transmission of downlink control information (DCI), uplink control information (UCI), and/or sidelink control information (SCI)).

Hereinafter, even when a method (e.g. transmission or reception of a signal) performed at a first communication node among communication nodes is described, a corresponding second communication node may perform a method (e.g. reception or transmission of the signal) corresponding to the method performed at the first communication node. That is, when an operation of a terminal is described, a base station corresponding to the terminal may perform an operation corresponding to the operation of the terminal. Conversely, when an operation of a base station is described, a terminal corresponding to the base station may perform an operation corresponding to the operation of the base station. In addition, when an operation of a first terminal is described, a second terminal corresponding to the first terminal may perform an operation corresponding to the operation of the first terminal. Conversely, when an operation of a second terminal is described, a first terminal corresponding to the second terminal may perform an operation corresponding to the operation of the second terminal.

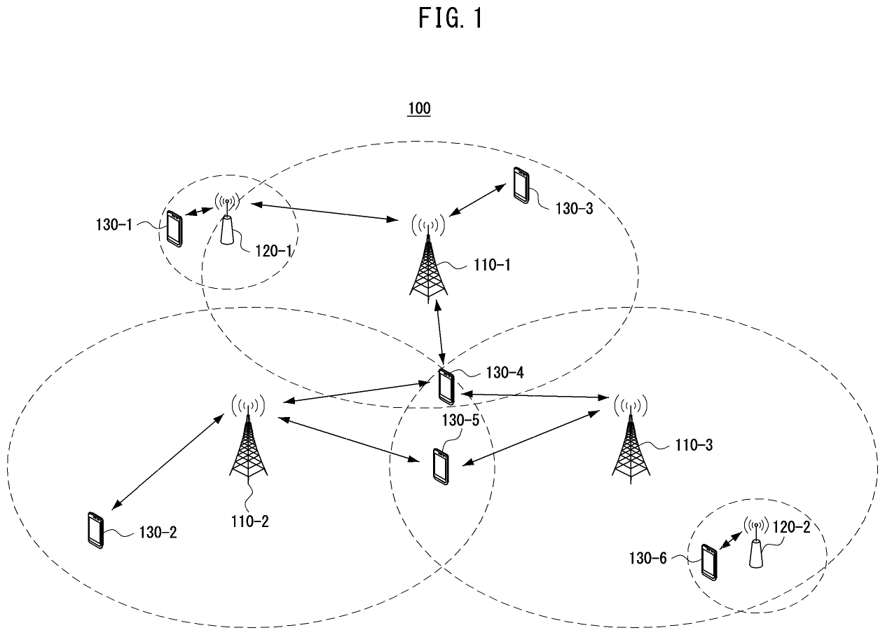

FIG. 1 is a conceptual diagram illustrating exemplary embodiments of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. In addition, the communication system 100 may further comprise a core network (e.g. a serving gateway (S-GW), a packet data network (PDN) gateway (P-GW), and a mobility management entity (MME)). When the communication system 100 is a 5G communication system (e.g. new radio (NR) system), the core network may include an access and mobility management function (AMF), a user plane function (UPF), a session management function (SMF), and the like.

The plurality of communication nodes 110 to 130 may support a communication protocol defined by the 3rd generation partnership project (3GPP) specifications (e.g. LTE communication protocol, LTE-A communication protocol, NR communication protocol, or the like). The plurality of communication nodes 110 to 130 may support code division multiple access (CDMA) technology, wideband CDMA (WCDMA) technology, time division multiple access (TDMA) technology, frequency division multiple access (FDMA) technology, orthogonal frequency division multiplexing (OFDM) technology, filtered OFDM technology, cyclic prefix OFDM (CP-OFDM) technology, discrete Fourier transform-spread-OFDM (DFT-s-OFDM) technology, orthogonal frequency division multiple access (OFDMA) technology, single carrier FDMA (SC-FDMA) technology, non-orthogonal multiple access (NOMA) technology, generalized frequency division multiplexing (GFDM) technology, filter band multi-carrier (FBMC) technology, universal filtered multi-carrier (UFMC) technology, space division multiple access (SDMA) technology, or the like. Each of the plurality of communication nodes may have the following structure.

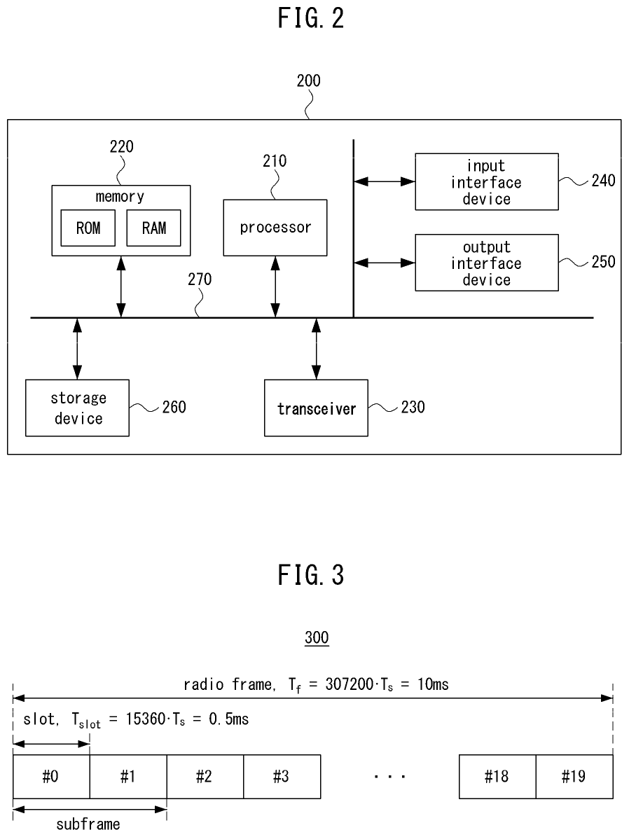

FIG. 2 is a block diagram illustrating exemplary embodiments of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), a evolved Node-B (eNB), a gNB, an advanced base station (ABS), a high reliability-base station (HR-BS), a base transceiver station (BTS), a radio base station, a radio transceiver, an access point, an access node, a radio access station (RAS), a mobile multihop relay-base station (MMR-BS), a relay station (RS), an advanced relay station (ARS), a high reliability-relay station (HR-RS), a home NodeB (HNB), a home eNodeB (HeNB), a road side unit (RSU), a radio remote head (RRH), a transmission point (TP), a transmission and reception point (TRP), or the like.

Each of the plurality of terminals 130-1, 130-2, 130-3, 130-4, 130-5, and 130-6 may refer to a user equipment (UE), a terminal equipment (TE), an advanced mobile station (AMS), a high reliability-mobile station (HR-MS), a terminal, an access terminal, a mobile terminal, a station, a subscriber station, a mobile station, a portable subscriber station, a node, a device, an on-board unit (OBU), or the like.

Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g. a single-user MIMO (SU-MIMO), a multi-user MIMO (MU-MIMO), a massive MIMO, or the like), a coordinated multipoint (COMP) transmission, a carrier aggregation (CA) transmission, a transmission in unlicensed band, device-to-device (D2D) communication (or, proximity services (ProSe)), Internet of Things (IoT) communications, dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e. the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the COMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Meanwhile, the communication system may support three types of frame structures. A type 1 frame structure may be applied to a frequency division duplex (FDD) communication system, a type 2 frame structure may be applied to a time division duplex (TDD) communication system, and a type 3 frame structure may be applied to an unlicensed band based communication system (e.g. a licensed assisted access (LAA) communication system).

FIG. 3 is a conceptual diagram illustrating exemplary embodiments of a type 1 frame.

Referring to FIG. 3, a radio frame 300 may comprise 10 subframes, and a subframe may comprise 2 slots. Thus, the radio frame 300 may comprise 20 slots (e.g. slot #0, slot #1, slot #2, slot #3, . . . , slot #18, and slot #19). The length T_{f} of the radio frame 300 may be 10 milliseconds (ms). The length of the subframe may be 1 ms, and the length Tₛₗₒₜ of a slot may be _{0.5} ms. Here, Tₛ may indicate a sampling time, and may be 1/30,720,000 s.

The slot may be composed of a plurality of OFDM symbols in the time domain, and may be composed of a plurality of resource blocks (RBs) in the frequency domain. The RB may be composed of a plurality of subcarriers in the frequency domain. The number of OFDM symbols constituting the slot may vary depending on configuration of a cyclic prefix (CP). The CP may be classified into a normal CP and an extended CP. If the normal CP is used, the slot may be composed of 7 OFDM symbols, in which case the subframe may be composed of 14 OFDM symbols. If the extended CP is used, the slot may be composed of 6 OFDM symbols, in which case the subframe may be composed of 12 OFDM symbols.

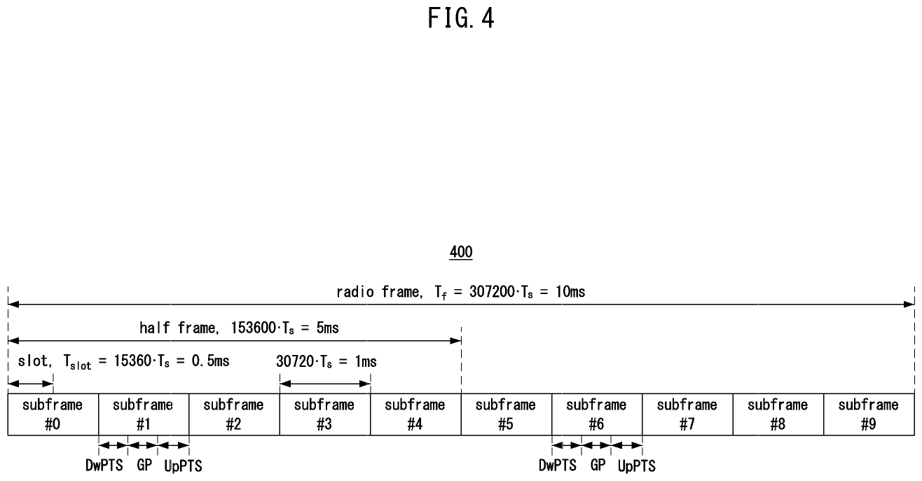

FIG. 4 is a conceptual diagram illustrating exemplary embodiments of a type 2 frame.

Referring to FIG. 4, a radio frame 400 may comprise two half frames, and a half frame may comprise 5 subframes. Thus, the radio frame 400 may comprise 10 subframes. The length T_{f} of the radio frame 400 may be 10 ms. The length of the half frame may be 5 ms. The length of the subframe may be 1 ms. Here, Tₛ may be 1/30,720,000s.

The radio frame 400 may include at least one downlink subframe, at least one uplink subframe, and a least one special subframe. Each of the downlink subframe and the uplink subframe may include two slots. The length Tₛₗₒₜ of a slot may be 0.5 ms. Among the subframes included in the radio frame 400, each of the subframe #1 and the subframe #6 may be a special subframe. For example, when a switching periodicity between downlink and uplink is 5 ms, the radio frame 400 may include 2 special subframes. Alternatively, the switching periodicity between downlink and uplink is 10 ms, the radio frame 400 may include one special subframe. The special subframe may include a downlink pilot time slot (DwPTS), a guard period (GP), and an uplink pilot time slot (UpPTS).

The downlink pilot time slot may be regarded as a downlink interval and may be used for cell search, time and frequency synchronization acquisition of the terminal, channel estimation, and the like. The guard period may be used for resolving interference problems of uplink data transmission caused by delay of downlink data reception. Also, the guard period may include a time required for switching from the downlink data reception operation to the uplink data transmission operation. The uplink pilot time slot may be used for uplink channel estimation, time and frequency synchronization acquisition, and the like. Transmission of a physical random access channel (PRACH) or a sounding reference signal (SRS) may be performed in the uplink pilot time slot.

The lengths of the downlink pilot time slot, the guard period, and the uplink pilot time slot included in the special subframe may be variably adjusted as needed. In addition, the number and position of each of the downlink subframe, the uplink subframe, and the special subframe included in the radio frame 400 may be changed as needed.

In the communication system, a transmission time interval (TTI) may be a basic time unit for transmitting coded data through a physical layer. A short TTI may be used to support low latency requirements in the communication system. The length of the short TTI may be less than 1 ms. The conventional TTI having a length of 1 ms may be referred to as a base TTI or a regular TTI. That is, the base TTI may be composed of one subframe. In order to support transmission on a base TTI basis, signals and channels may be configured on a subframe basis. For example, a cell-specific reference signal (CRS), a physical downlink control channel (PDCCH), a physical downlink shared channel (PDSCH), a physical uplink control channel (PUCCH), a physical uplink shared channel (PUSCH), and the like may exist in each subframe.

On the other hand, a synchronization signal (e.g. a primary synchronization signal (PSS) and a secondary synchronization signal (SSS)) may exist for every 5 subframes, and a physical broadcast channel (PBCH) may exist for every 10 subframes. Also, each radio frame may be identified by an SFN, and the SFN may be used for defining transmission of a signal (e.g. a paging signal, a reference signal for channel estimation, a signal for channel state information, etc.) longer than one radio frame. The periodicity of the SFN may be 1024.

In the LTE system, the PBCH may be a physical layer channel used for transmission of system information (e.g. master information block (MIB)). The PBCH may be transmitted every 10 subframes. That is, the transmission periodicity of the PBCH may be 10 ms, and the PBCH may be transmitted once in the radio frame. The same MIB may be transmitted during 4 consecutive radio frames, and after 4 consecutive radio frames, the MIB may be changed according to a situation of the LTE system. The transmission period for which the same MIB is transmitted may be referred to as a ‘PBCH TTI’, and the PBCH TTI may be 40 ms. That is, the MIB may be changed for each PBCH TTI.

The MIB may be composed of 40 bits. Among the 40 bits constituting the MIB, 3 bits may be used to indicate a system band, 3 bits may be used to indicate physical hybrid automatic repeat request (ARQ) indicator channel (PHICH) related information, 8 bits may be used to indicate an SFN, 10 bits may be configured as reserved bits, and 16 bits may be used for a cyclic redundancy check (CRC).

The SFN for identifying the radio frame may be composed of a total of 10 bits (B9 to B0), and the most significant bits (MSBs) 8 bits (B9 to B2) among the 10 bits may be indicated by the PBCH (i.e. MIB). The MSBs 8 bits (B9 to B2) of the SFN indicated by the PBCH (i.e. MIB) may be identical during 4 consecutive radio frames (i.e. PBCH TTI). The least significant bits (LSBs) 2 bits (B1 to B0) of the SFN may be changed during 4 consecutive radio frames (i.e. PBCH TTI), and may not be explicitly indicated by the PBCH (i.e. MIB). The LSBs (2 bits (B1 to B0)) of the SFN may be implicitly indicated by a scrambling sequence of the PBCH (hereinafter referred to as ‘PBCH scrambling sequence’).

A gold sequence generated by being initialized by a cell ID may be used as the PBCH scrambling sequence, and the PBCH scrambling sequence may be initialized for each four consecutive radio frames (e.g. each PBCH TTI) based on an operation of ‘mod (SFN, 4)’. The PBCH transmitted in a radio frame corresponding to an SFN with LSBs 2 bits (B1 to B0) set to ‘00’ may be scrambled by the gold sequence generated by being initialized by the cell ID. Thereafter, the gold sequences generated according to the operation of ‘mod (SFN, 4)’ may be used to scramble the PBCH transmitted in the radio frames corresponding to SFNs with LSBs 2 bits (B1 to B0) set to ‘01’, ‘10’, and ‘11’.

Accordingly, the terminal having acquired the cell ID in the initial cell search process may identify the value of the LSBs 2 bits (B1 to B0) of the SFN (e.g. ‘00’, ‘01’, ‘10’, or ‘11’) based on the PBCH scramble sequence obtained in the decoding process for the PBCH (i.e. MIB). The terminal may use the LSBs 2 bits (B1 to B0) of the SFN obtained based on the PBCH scrambling sequence and the MSBs 8 bits (B9 to B2) of the SFN indicated by the PBCH (i.e. MIB) so as to identify the SFN (i.e. the entire bits B9 to B0 of the SFN).

On the other hand, the communication system may support not only a high transmission rate but also technical requirements for various service scenarios. For example, the communication system may support an enhanced mobile broadband (eMBB) service, an ultra-reliable low-latency communication (URLLC) service, a massive machine type communication (mMTC) service, and the like.

The subcarrier spacing of the communication system (e.g. OFDM-based communication system) may be determined based on a carrier frequency offset (CFO) and the like. The CFO may be generated by a Doppler effect, a phase drift, or the like, and may increase in proportion to an operation frequency. Therefore, in order to prevent the performance degradation of the communication system due to the CFO, the subcarrier spacing may increase in proportion to the operation frequency. On the other hand, as the subcarrier spacing increases, a CP overhead may increase. Therefore, the subcarrier spacing may be configured based on a channel characteristic, a radio frequency (RF) characteristic, etc. according to a frequency band.

The communication system may support numerologies defined in Table 1 below.

TABLE 1

| Numerology (μ) | 0 | 1 | 2 | 3 | 4 | 5 |
|---|---|---|---|---|---|---|
| Subcarrier | 15 kHz | 30 kHz | 60 kHz | 120 kHz | 240 kHz | 480 kHz |
| spacing | | | | | | |
| OFDM symbol | 66.7 | 33.3 | 16.7 | 8.3 | 4.2 | 2.1 |
| length [us] | | | | | | |
| CP length [us] | 4.76 | 2.38 | 1.19 | 0.60 | 0.30 | 0.15 |
| Number of | 14 | 28 | 56 | 112 | 224 | 448 |
| OFDM symbols | | | | | | |
| within 1 ms | | | | | | |

For example, the subcarrier spacing of the communication system may be configured to 15 kHz, 30 kHz, 60 kHz, or 120 kHz. The subcarrier spacing of the LTE system may be 15 kHz, and the subcarrier spacing of the NR system may be 1, 2, 4, or 8 times the conventional subcarrier spacing of 15 kHz. If the subcarrier spacing increases by exponentiation units of 2 of the conventional subcarrier spacing, the frame structure can be easily designed.

The communication system may support FR1 as well as FR2. The FR2 may be classified into FR2-1 and FR2-2. The FR1 may be a frequency band of 6 GHz or below, the FR2-1 may be a frequency band of 24.25 to 52.6, and the FR2-2 may be a frequency band of 52.6 to 71 GHz. In an exemplary embodiment, the FR2 may be the FR2-1, the FR2-1, or a frequency band including the FR2-1 and FR2-2. In each of the FR1, FR2-1, and FR2-2, subcarrier spacings available for data transmission may be defined as shown in Table 2 below.

In each of the FR1, the FR2-1, and the FR2-2, SCSs available for synchronization signal block (SSB) transmission may be defined as shown in Table 3 below. In each of the FR1, the FR2-1, and the FR2-2, SCSs available for RACH transmission (e.g. Msg1 or Msg-A) may be defined as shown in Table 4 below.

TABLE 2
data

| FR1 | FR2-1 | FR2-2 |
|---|---|---|
| 15 kHz, 30 kHz, | 60 kHz, 120 kHz | 120 kHz, 480 kHz, |
| 60 kHz (optional) | | 960 kHz |

TABLE 3
SSB

| FR1 | FR2-1 | FR2-2 |
|---|---|---|
| 15 kHz, 30 kHz | 120 kHz, 240 kHz | 120 kHz, 480 kHz, |
| | | 960 kHz |

TABLE 4
RACH

| FR1 | FR2-1 | FR2-2 |
|---|---|---|
| 1.25 kHz, 5 kHz, 15 | 60 kHz, 120 kHz | 120 kHz, 480 kHz, |
| kHz, 30 kHz | | 960 kHz |

The communication system may support a wide frequency band (e.g. several hundred MHz to tens of GHz). Since the diffraction characteristic and the reflection characteristic of the radio wave are poor in a high frequency band, a propagation loss (e.g. path loss, reflection loss, and the like) in a high frequency band may be larger than a propagation loss in a low frequency band. Therefore, a cell coverage of a communication system supporting a high frequency band may be smaller than a cell coverage of a communication system supporting a low frequency band. In order to solve such the problem, a beamforming scheme based on a plurality of antenna elements may be used to increase the cell coverage in the communication system supporting a high frequency band.

The beamforming scheme may include a digital beamforming scheme, an analog beamforming scheme, a hybrid beamforming scheme, and the like. In the communication system using the digital beamforming scheme, a beamforming gain may be obtained using a plurality of RF paths based on a digital precoder or a codebook. In the communication system using the analog beamforming scheme, a beamforming gain may be obtained using analog RF devices (e.g. phase shifter, power amplifier (PA), variable gain amplifier (VGA), and the like) and an antenna array.

Because of the need for expensive digital to analog converters (DACs) or analog to digital converters (ADCs) for digital beamforming schemes and transceiver units corresponding to the number of antenna elements, the complexity of antenna implementation may be increased to increase the beamforming gain. In case of the communication system using the analog beamforming scheme, since a plurality of antenna elements are connected to one transceiver unit through phase shifters, the complexity of the antenna implementation may not increase greatly even if the beamforming gain is increased. However, the beamforming performance of the communication system using the analog beamforming scheme may be lower than the beamforming performance of the communication system using the digital beamforming scheme. Further, in the communication system using the analog beamforming scheme, since the phase shifter is adjusted in the time domain, frequency resources may not be efficiently used. Therefore, a hybrid beam forming scheme, which is a combination of the digital scheme and the analog scheme, may be used.

When the cell coverage is increased by the use of the beamforming scheme, common control channels and common signals (e.g. reference signal and synchronization signal) for all terminals belonging to the cell coverage as well as control channels and data channels for each terminal may also be transmitted based on the beamforming scheme. In this case, the common control channels and the common signals for all terminals belonging to the cell coverage may be transmitted based on a beam sweeping scheme.

In addition, in the NR system, a synchronization signal/physical broadcast channel (SS/PBCH) block may also be transmitted in a beam sweeping scheme. The SS/PBCH block may be composed of a PSS, an SSS, a PBCH, and the like. In the SS/PBCH block, the PSS, the SSS, and the PBCH may be configured in a time division multiplexing (TDM) manner. The SS/PBCH block may be referred also to as an ‘SS block (SSB)’. One SS/PBCH block may be transmitted using N consecutive OFDM symbols. Here, N may be an integer equal to or greater than 4. The base station may periodically transmit the SS/PBCH block, and the terminal may acquire frequency/time synchronization, a cell ID, system information, and the like based on the SS/PBCH block received from the base station. The SS/PBCH block may be transmitted as follows.

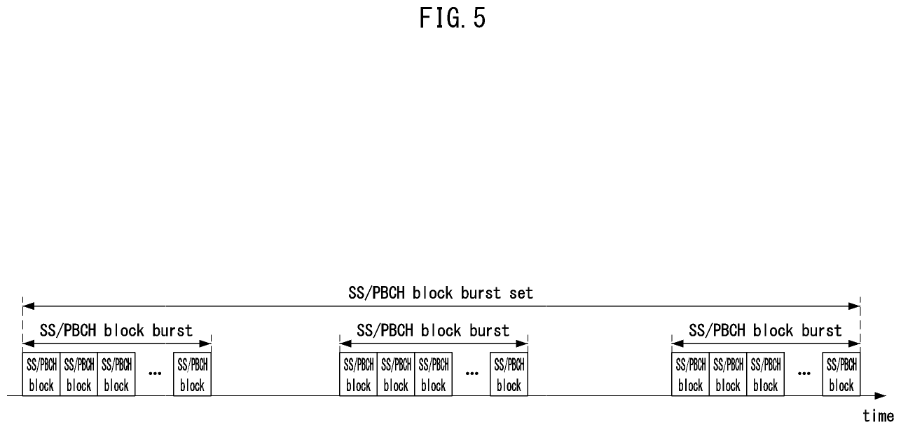

FIG. 5 is a conceptual diagram illustrating exemplary embodiments of a first transmission method of SS/PBCH blocks in a communication system.

Referring to FIG. 5, one or more SS/PBCH blocks may be transmitted in a beam sweeping scheme within an SS/PBCH block burst set. Up to L SS/PBCH blocks may be transmitted within one SS/PBCH block burst set. L may be an integer equal to or greater than 2, and may be defined in the 3GPP standard. Depending on a region of a system frequency, L may vary. Within the SS/PBCH block burst set, the SS/PBCH blocks may be located consecutively or distributedly. The consecutive SS/PBCH blocks may be referred to as an ‘SS/PBCH block burst’. The SS/PBCH block burst set may be repeated periodically, and system information (e.g. MIB) transmitted through the PBCHs of the SS/PBCH blocks within the SS/PBCH block burst set may be the same. An index of the SS/PBCH block, an index of the SS/PBCH block burst, an index of an OFDM symbol, an index of a slot, and the like may be indicated explicitly or implicitly by the PBCH.

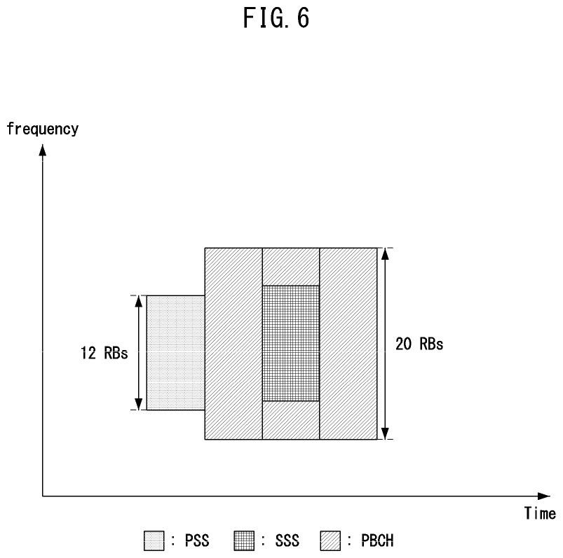

FIG. 6 is a conceptual diagram illustrating exemplary embodiments of an SS/PBCH block in a communication system.

Referring to FIG. 6, signals and a channel are arranged within one SS/PBCH block in the order of ‘PSS→PBCH→SSS→PBCH’. The PSS, SSS, and PBCH within the SS/PBCH block may be configured in a TDM scheme. In a symbol where the SSS is located, the PBCH may be located in frequency resources above the SSS and frequency resources below the SSS. That is, the PBCH may be transmitted in both end bands adjacent to the frequency band in which the SSS is transmitted. When the maximum number of SS/PBCH blocks is 8 in the sub 6 GHz frequency band, an SS/PBCH block index may be identified based on a demodulation reference signal used for demodulating the PBCH (hereinafter, referred to as ‘PBCH DMRS’). When the maximum number of SSBs is 64 in the over 6 GHz frequency band, LSB 3 bits of 6 bits representing the SS/PBCH block index may be identified based on the PBCH DMRS, and the remaining MSB 3 bits may be identified based on a payload of the PBCH.

The maximum system bandwidth that can be supported in the NR system may be 400 MHz. The size of the maximum bandwidth that can be supported by the terminal may vary depending on the capability of the terminal. Therefore, the terminal may perform an initial access procedure (e.g. initial connection procedure) by using some of the system bandwidth of the NR system supporting a wide band. In order to support access procedures of terminals supporting various sizes of bandwidths, SS/PBCH blocks may be multiplexed in the frequency domain within the system bandwidth of the NR system supporting a wide band. In this case, the SS/PBCH blocks may be transmitted as follows.

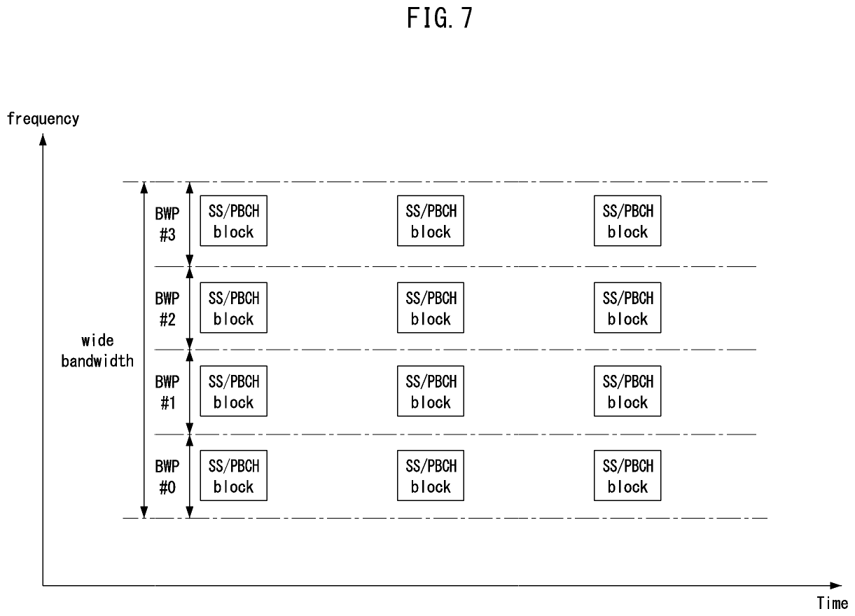

FIG. 7 is a conceptual diagram illustrating exemplary embodiments of a second transmission method of SS/PBCH blocks in a communication system.

Referring to FIG. 7, a wideband component carrier (CC) may include a plurality of bandwidth parts (BWPs). For example, the wideband CC may include 4 BWPs. The base station may transmit SS/PBCH blocks in the respective BWPs #0 to #3 belonging to the wideband CC. The terminal may receive the SS/PBCH block(s) from one or more BWPs of the BWPs #0 to #3, and may perform an initial access procedure using the received SS/PBCH block.

After detecting the SS/PBCH block, the terminal may acquire system information (e.g. remaining minimum system information (RMSI)), and may perform a cell access procedure based on the system information. The RMSI may be transmitted on a PDSCH scheduled by a PDCCH. Configuration information of a control resource set (CORESET) in which the PDCCH including scheduling information of the PDSCH through which the RMSI is transmitted may be transmitted on a PBCH within the SS/PBCH block. A plurality of SS/PBCH blocks may be transmitted in the entire system band, and one or more SS/PBCH blocks among the plurality of SS/PBCH blocks may be SS/PBCH block(s) associated with the RMSI. The remaining SS/PBCH blocks may not be associated with the RMSI. The SS/PBCH block associated with the RMSI may be defined as a ‘cell defining SS/PBCH block’. The terminal may perform a cell search procedure and an initial access procedure by using the cell-defining SS/PBCH block. The SS/PBCH block not associated with the RMSI may be used for a synchronization procedure and/or a measurement procedure in the corresponding BWP. The BWP(s) through which the SS/PBCH block is transmitted may be limited to one or more BWPs within a wide bandwidth.

The positions at which the SSBs are transmitted in the time domain may be defined differently according to an SCS and a value of L. In exemplary embodiments, the SCS may mean a subcarrier size. The SSB may be transmitted in some symbols within one slot, and a short UL transmission (e.g. uplink control information (UCI) transmission) may be performed in the remaining symbols not used for the SSB transmission within one slot. When the SSB is transmitted in radio resources to which a large SCS (e.g. 120 kHz SCS or 240 kHz SCS) is applied, a gap may be configured in the middle of consecutive slots including the SSB so that a long UL transmission (e.g. transmission of URLLC traffic) can be performed at least every 1 ms.

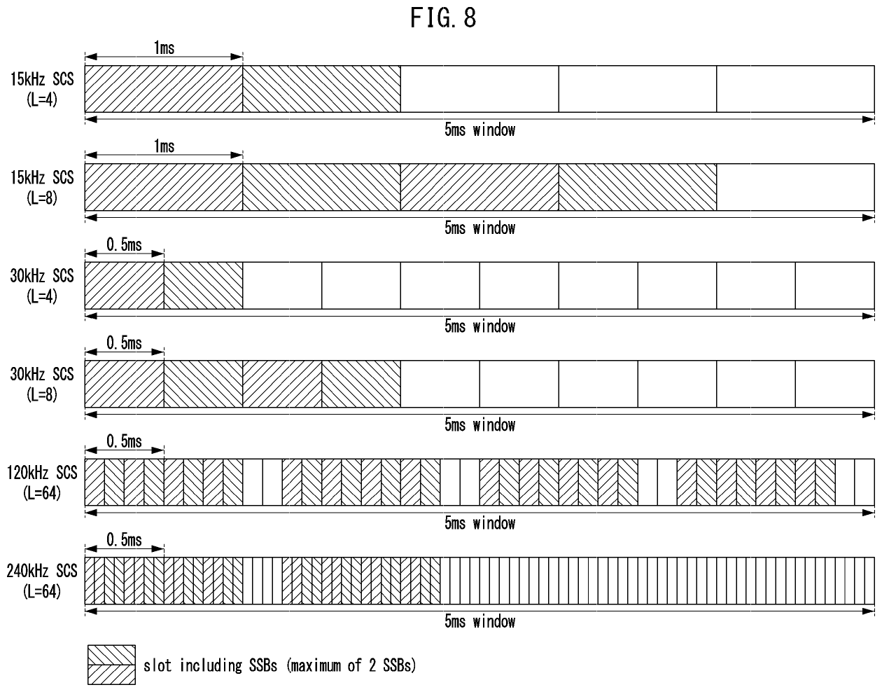

FIG. 8 is a conceptual diagram illustrating exemplary embodiments of SSB burst configuration.

Referring to FIG. 8, in a transmission procedure of SSBs (e.g. SSB burst) in radio resources to which a 120 kHz SCS is applied, the base station may transmit SSBs in 8 consecutive slots. In a transmission procedure of SSBs in radio resources to which is 240 kHz SCS is applied, the base station may transmit SSBs in 16 consecutive slots. In the radio resources to which the 120 kHz SCS or 240 kHz SCS is applied, a gap for UL transmission may be configured.

The RMSI may be obtained by performing an operation to obtain configuration information of a CORESET from the SS/PBCH block (e.g. PBCH), an operation of detecting a PDCCH based on the configuration information of the CORESET, an operation to obtain scheduling information of a PDSCH from the PDCCH, and an operation to receive the RMSI on the PDSCH. A transmission resource of the PDCCH may be configured by the configuration information of the CORESET. A mapping patter of the RMSI CORESET pattern may be defined as follows. The RMSI CORESET may be a CORESET used for transmission and reception of the RMSI.

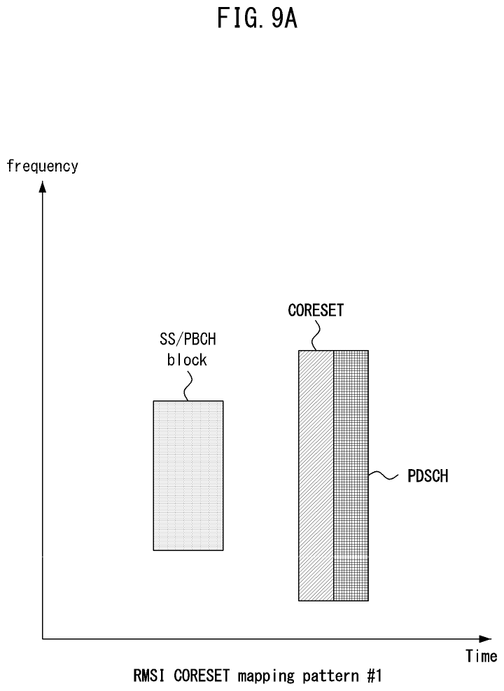

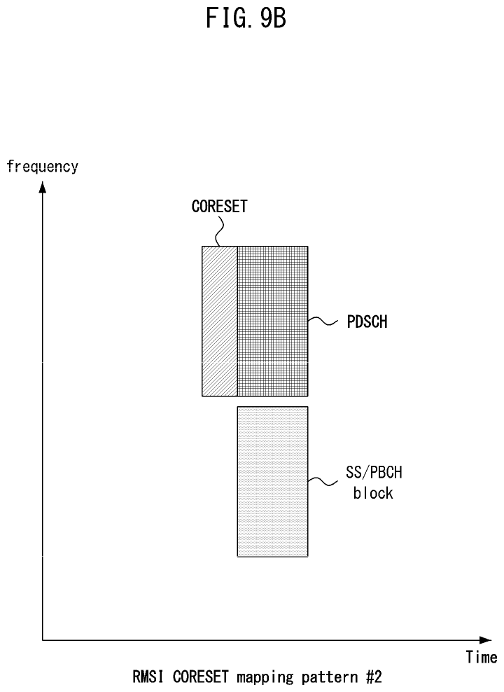

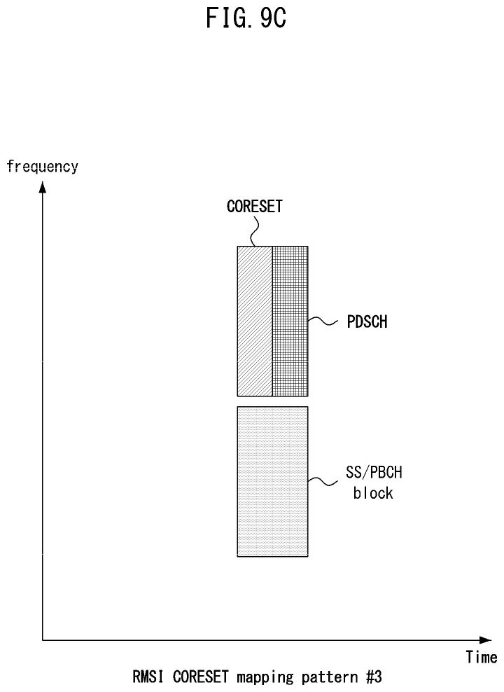

FIG. 9A is a conceptual diagram illustrating an RMSI CORESET mapping pattern #1 in a communication system, FIG. 9B is a conceptual diagram illustrating an RMSI CORESET mapping pattern #2 in a communication system, and FIG. 9C is a conceptual diagram illustrating an RMSI CORESET mapping pattern #3 in a communication system.

Referring to FIGS. 9A to 9C, one RMSI CORESET mapping pattern among the RMSI CORESET mapping patterns #1 to #3 may be used, and a detailed configuration according to the one RMSI CORESET mapping pattern may be determined. In the RMSI CORESET mapping pattern #1, the SS/PBCH block, the CORESET (i.e. RMSI CORESET), and the PDSCH (i.e. RMSI PDSCH) may be configured in a TDM scheme. The RMSI PDSCH may mean the PDSCH through which the RMSI is transmitted. In the RMSI CORESET mapping pattern #2, the CORESET (i.e. RMSI CORESET) and the PDSCH (i.e. RMSI PDSCH) may be configured in a TDM scheme, and the PDSCH (i.e. RMSI PDSCH) and the SS/PBCH block may be configured in a frequency division multiplexing (FDM) scheme. In the RMSI CORESET mapping pattern #3, the CORESET (i.e. RMSI CORESET) and the PDSCH (i.e. RMSI PDSCH) may be configured in a TDM scheme, and the CORESET (i.e. RMSI CORESET) and the PDSCH (i.e. RMSI PDSCH) may be multiplexed with the SS/PBCH block in a FDM scheme.

In the frequency band of 6 GHz or below, only the RMSI CORESET mapping pattern #1 may be used. In the frequency band of 6 GHz or above, all of the RMSI CORESET mapping patterns #1, #2, and #3 may be used. The numerology of the SS/PBCH block may be different from that of the RMSI CORESET and the RMSI PDSCH. Here, the numerology may be a subcarrier spacing. In the RMSI CORESET mapping pattern #1, a combination of all numerologies may be used. In the RMSI CORESET mapping pattern #2, a combination of numerologies (120 kHz, 60 kHz) or (240 kHz, 120 kHz) may be used for the SS/PBCH block and the RMSI CORESET/PDSCH. In the RMSI CORESET mapping pattern #3, a combination of numerologies (120 kHz, 120 kHz) may be used for the SS/PBCH block and the RMSI CORESET/PDSCH.

One RMSI CORESET mapping pattern may be selected from the RMSI CORESET mapping patterns #1 to #3 according to the combination of the numerology of the SS/PBCH block and the numerology of the RMSI CORESET/PDSCH. The configuration information of the RMSI CORESET may include Table A and Table B. Table A may represent the number of resource blocks (RBs) of the RMSI CORESET, the number of symbols of the RMSI CORESET, and an offset between an RB (e.g. starting RB or ending RB) of the SS/PBCH block and an RB (e.g. starting RB or ending RB) of the RMSI CORESET. Table B may represent the number of search space sets per slot, an offset of the RMSI CORESET, and an OFDM symbol index in each of the RMSI CORESET mapping patterns. Table B may represent information for configuring a monitoring occasion of the RMSI PDCCH. Each of Table A and Table B may be composed of a plurality of sub-tables. For example, Table A may include sub-tables 13-1 to 13-8 defined in the technical specification (TS) 38.213, and Table B may include sub-tables 13-9 to 13-13 defined in the TS 38.213. The size of each of Table A and Table B may be 4 bits.

In the NR system, a PDSCH may be mapped to the time domain according to a PDSCH mapping type A or a PDSCH mapping type B. The PDSCH mapping types A and B may be defined as Table 5 below.

TABLE 5
PDSCH

| mapping | Normal CP | | | Extended CP | | |
|---|---|---|---|---|---|---|
| type | S | L | S + L | S | L | S + L |
| Type A | {0, 1, 2, 3} | {3, . . . , 14} | {3, . . . , 14} | {0, 1, 2, 3} | {3, . . . , 12} | {3, . . . , 12} |
| | (Note 1) | | | (Note 1) | | |
| Type B | {0, . . . , 12} | {2, 4, 7} | {2, . . . , 14} | {0, . . . , 10} | {2, 4, 6} | {2, . . . , 12} |

(Note 1):
S = 3 is applicable only if dmrs-TypeA-Position = 3

The type A (i.e. PDSCH mapping type A) may be slot-based transmission. When the type A is used, a position of a start symbol of a PDSCH may be configured to one of {0, 1, 2, 3}. When the type A and a normal CP are used, the number of symbols constituting the PDSCH (e.g. the duration of the PDSCH) may be configured to one of 3 to 14 within a range not exceeding a slot boundary. The type B (i.e. PDSCH mapping type B) may be non-slot-based transmission. When the type B is used, a position of a start symbol of a PDSCH may be configured to one of 0 to 12. When the type B and the normal CP are used, the number of symbols constituting the PDSCH (e.g. the duration of the PDSCH) may be configured to one of {2, 4, 7} within a range not exceeding a slot boundary. A DMRS (hereinafter, referred to as ‘PDSCH DMRS’) for demodulation of the PDSCH (e.g. data) may be determined by the PDSCH mapping type (e.g. type A or type B) and an ID indicating the length. The ID may be defined differently according to the PDSCH mapping type.

Meanwhile, NR-unlicensed (NR-U) is being discussed in the NR standardization meeting. The NR-U system may increase network capacity by improving the utilization of limited frequency resources. The NR-U system may support operation in an unlicensed band (e.g. unlicensed spectrum).

In the NR-U system, the terminal may determine whether a signal is transmitted from a base station based on a discovery reference signal (DRS) received from the corresponding base station in the same manner as in the general NR system. In the NR-U system in a Stand-Alone (SA) mode, the terminal may acquire synchronization and/or system information based on the DRS. In the NR-U system, the DRS may be transmitted according to a regulation of the unlicensed band (e.g. transmission band, transmit power, transmission time, etc.). For example, according to Occupied Channel Bandwidth (OCB) regulations, signals may be configured and/or transmitted to occupy 80% of the total channel bandwidth (e.g. 20 MHz).

In the NR-U system, a communication node (e.g. base station, terminal) may perform a Listen Before Talk (LBT) procedure before transmitting a signal and/or a channel for coexistence with another system. The signal may be a synchronization signal, a reference signal (e.g. DRS, DMRS, channel state information (CSI)-RS, phase tracking (PT)-RS, sounding reference signal (SRS)), or the like. The channel may be a downlink channel, an uplink channel, a sidelink channel, or the like. In exemplary embodiments, a signal may mean the ‘signal’, the ‘channel’, or the ‘signal and channel’. The LBT procedure may be an operation for checking whether a signal is transmitted by another communication node. If it is determined by the LBT procedure that there is no transmission signal (e.g. when the LBT procedure is successful), the communication node may transmit a signal in the unlicensed band. If it is determined by the LBT procedure that a transmission signal exists (e.g. when the LBT fails), the communication node may not be able to transmit a signal in the unlicensed band. The communication node may perform a LBT procedure according to one of various categories before transmission of a signal. The category of LBT may vary depending on the type of the transmission signal.

Meanwhile, NR vehicle-to-everything (V2X) communication technology is being discussed in the NR standardization meeting. The NR V2X communication technology may be a technology that supports communication between vehicles, communication between a vehicle and an infrastructure, communication between a vehicle and a pedestrian, and the like based on device-to-device (D2D) communication technologies. Techniques for reducing power consumption and improving reliability are being discussed for NR V2C communication.

The NR V2X communication (e.g. sidelink communication) may be performed according to three transmission schemes (e.g. unicast scheme, broadcast scheme, groupcast scheme). When the unicast scheme is used, a PC5-RRC connection may be established between a first terminal (e.g. transmitting terminal that transmits data) and a second terminal (e.g. receiving terminal that receives data), and the PC5-RRC connection may refer to a logical connection for a pair between a source ID of the first terminal and a destination ID of the second terminal. The first terminal may transmit data (e.g. sidelink data) to the second terminal. When the broadcast scheme is used, the first terminal may transmit data to all terminals. When the groupcast scheme is used, the first terminal may transmit data to a group (e.g. groupcast group) composed of a plurality of terminals. In SL communication (e.g. SL-U communication), a transmitting terminal may mean a terminal transmitting data, and a receiving terminal may mean a terminal receiving the data.

When the unicast scheme is used, the second terminal may transmit feedback information (e.g. acknowledgment (ACK) or negative ACK (NACK)) to the first terminal in response to data received from the first terminal. In the exemplary embodiments below, the feedback information may be referred to as a ‘HARQ-ACK’, ‘feedback signal’, a ‘physical sidelink feedback channel (PSFCH) signal’, or the like. When ACK is received from the second terminal, the first terminal may determine that the data has been successfully received at the second terminal. When NACK is received from the second terminal, the first terminal may determine that the second terminal has failed to receive the data. In this case, the first terminal may transmit additional information to the second terminal based on an HARQ scheme. Alternatively, the first terminal may improve a reception probability of the data at the second terminal by retransmitting the same data to the second terminal.

When the broadcast scheme is used, a procedure for transmitting feedback information for data may not be performed. For example, system information may be transmitted in the broadcast scheme, and the terminal may not transmit feedback information for the system information to the base station. Therefore, the base station may not identify whether the system information has been successfully received at the terminal. To solve this problem, the base station may periodically broadcast the system information.

When the groupcast scheme is used, a procedure for transmitting feedback information for data may not be performed. For example, necessary information may be periodically transmitted in the groupcast scheme, without the procedure for transmitting feedback information. However, when the candidates of terminals participating in the groupcast scheme-based communication and/or the number of the terminals participating in that is limited, and the data transmitted in the groupcast scheme is data that should be received within a preconfigured time (e.g. data sensitive to delay), it may be necessary to transmit feedback information also in the groupcast sidelink communication. The groupcast sidelink communication may mean sidelink communication performed in the groupcast scheme. When the feedback information transmission procedure is performed in the groupcast sidelink communication, data can be transmitted and received efficiently and reliably.

In the groupcast sidelink communication, two HARQ-ACK feedback schemes (i.e. transmission procedures of feedback information) may be supported. When the number of receiving terminals in a sidelink group is large and a service scenario 1 is supported, some receiving terminals belonging to a specific range within the sidelink group may transmit NACK through a PSFCH when data reception fails. This scheme may be a groupcast HARQ-ACK feedback option 1. In the service scenario 1, instead of all the receiving terminals in the sidelink group, it may be allowed for some receiving terminals belonging to a specific range to perform reception in a best-effort manner. The service scenario 1 may be an extended sensor scenario in which some receiving terminals belonging to a specific range need to receive the same sensor information from a transmitting terminal. In exemplary embodiments, the transmitting terminal may refer to a terminal transmitting data, and the receiving terminal may refer to a terminal receiving data.

When the number of receiving terminals in the sidelink group is limited and a service scenario 2 is supported, each of all the receiving terminals belonging to the sidelink group may report HARQ-ACK for data individually through a separate PSFCH. This scheme may be a groupcast HARQ-ACK feedback option 2. In the service scenario 2, since PSFCH resources are sufficient, the transmitting terminal may perform monitoring on HARQ-ACK feedbacks of all the receiving terminals belonging to the sidelink group, and data reception may be guaranteed at all the receiving terminals belonging to the sidelink group.

As in broadcast sidelink communication, data may be transmitted and received without an HARQ-ACK feedback procedure in unicast sidelink communication and groupcast sidelink communication. In this case, in order to increase a probability of receiving the data, a transmitting terminal may retransmit the data a preset number of times.

In all transmission schemes (e.g. unicast transmission, groupcast transmission, and broadcast transmission), whether an HARQ-ACK feedback procedure is applied may be statically or semi-statically configured to the terminal(s) by signaling (e.g. system information signaling, PC5-RRC signaling, UE-specific RRC signaling, control information signaling). In sidelink communication, HARQ-ACK feedback information may be transmitted on a PSFCH. If reception of a PSSCH is successful, a receiving terminal may transmit ACK for the PSSCH (e.g. data) on the PSFCH. If reception of the PSSCH fails, the receiving terminal may transmit NACK for the PSSCH (e.g. data) on the PSFCH. The PSFCH may be a channel for reporting ACK/NACK information (e.g. HARQ-ACK feedback) to the transmitting terminal. A resource region (e.g. PSFCH resource region) for PSFCH transmission (e.g. transmission of HARQ-ACK feedback) may be preconfigured within a specific resource pool. The PSFCH (e.g. PSFCH resource or PSFH resource region) may be configured periodically. A PSFCH periodicity for the PSFCH resource may be k slots (e.g. logical sidelink (SL) slots). k may be a natural number. For example, k may be 1, 2, or 4.

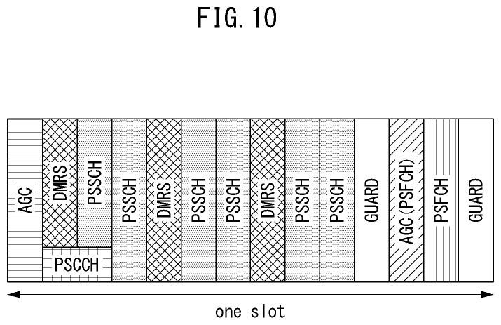

FIG. 10 is a conceptual diagram illustrating exemplary embodiments of configuration of a slot in which a PSFCH is configured.

Referring to FIG. 10, a PSFCH (e.g. HARQ-ACK feedback) may be repeatedly transmitted in two symbols (e.g. two OFDM symbols) within a slot (e.g. SL slot). The first symbol among two symbols in which the PSFCH is transmitted may be used for automatic gain control (AGC) for correct PSFCH receive power level adjustment.

The PSFCH may be transmitted within a frequency resource region preconfigured by system information. In this case, the frequency resource region for PSFCH transmission may be indicated (e.g. signaled) in form of a bitmap within the resource pool. The receiving terminal may implicitly select a location of the frequency resource region for PSFCH transmission based on indexes of a slot and a subchannel in which a PSSCH is received. The receiving terminal may identify the number of resource blocks (RBs) and the number of PSFCH resources multiplexable based on cyclic shifts of a PSFCH sequence within the frequency resource region. The receiving terminal may implicitly select a PSFCH index for PSFCH resource(s) based on a source identifier (ID) and a member ID. The source ID may be a physical layer source ID. The source ID may be an ID of a transmitting terminal that has transmitted the PSSCH.

The member ID may be used in the groupcast HARQ-ACK feedback option 2. When the groupcast HARQ-ACK feedback option 2 is applied, each of all receiving terminals within a group may individually transmit an HARQ-ACK feedback for SL data through a separate PSFCH (e.g. PSFCH resource). In a case other than the above-described exemplary embodiment, the member ID may be set to 0.

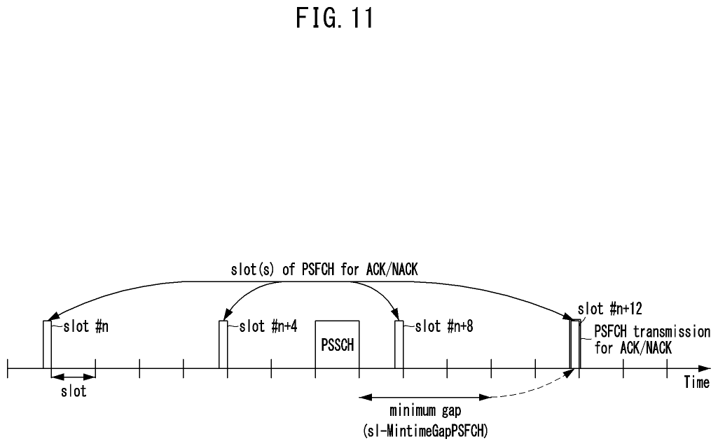

FIG. 11 is a conceptual diagram illustrating exemplary embodiments of a PSFCH for ACK/NACK transmission.

Referring to FIG. 11, a transmission time of a PSFCH may be the first slot (e.g. PSFCH slot) in which PSFCH transmission is possible after a preset time (e.g. sl-MinTimeGapPSFCH) from a reception time of a corresponding PSSCH. The PSFCH slot may be a slot capable of transmitting a PSFCH and/or a slot in which a PSFCH is configured. sl-MinTimeGapPSFCH may be set in consideration of a time required for processing the PSSCH after reception of the PSSCH and a time required for preparing for ACK/NACK (e.g. HARQ-ACK feedback) depending on whether reception of the PSSCH is successful. sl-MinTimeGapPSFCH may be set to 2 or 3 slots. The terminal (e.g. receiving terminal) may transmit the PSFCH in a slot #n+12, which is a slot capable of PSFCH transmission, after sl-MinTimeGapPSFCH (e.g. 3 slots) from a reception time of the PSSCH. n may be an integer greater than or equal to 0. In the present disclosure, the reception time may mean a reception start time and/or a reception end time, and the transmission time may mean a transmission start time and/or a transmission end time. The time may mean a timing and/or duration.

Data reliability at the receiving terminal may be improved by appropriately adjusting a transmit power of the transmitting terminal according to a transmission environment. Interference to other terminals may be mitigated by appropriately adjusting the transmit power of the transmitting terminal. Energy efficiency can be improved by reducing unnecessary transmit power. A power control scheme may be classified into an open-loop power control scheme and a closed-loop power control scheme. In the open-loop power control scheme, the transmitting terminal may determine the transmit power in consideration of configuration, a measured environment, etc. In the closed-loop power control scheme, the transmitting terminal may determine the transmit power based on a transmit power control (TPC) command received from the receiving terminal.

It may be difficult due to various causes including a multipath fading channel, interference, and the like to predict a received signal strength at the receiving terminal. Accordingly, the receiving terminal may adjust a receive power level (e.g. receive power range) by performing an automatic gain control (AGC) operation to prevent a quantization error of the received signal and maintain a proper receive power. In the communication system, the terminal may perform the AGC operation using a reference signal received from the base station. However, in the sidelink communication (e.g. V2X communication), the reference signal may not be transmitted from the base station. That is, in the sidelink communication, communication between terminals may be performed without the base station. Therefore, it may be difficult to perform the AGC operation in the sidelink communication. In the sidelink communication, the transmitting terminal may first transmit a signal (e.g. reference signal) to the receiving terminal before transmitting data, and the receiving terminal may adjust a receive power range (e.g. receive power level) by performing an AGC operation based on the signal received from the transmitting terminal. Thereafter, the transmitting terminal may transmit sidelink data to the receiving terminal. The signal used for the AGC operation may be a signal duplicated from a signal to be transmitted later or a signal preconfigured between the terminals.

A time period required for the ACG operation may be 15 μs. When a subcarrier spacing of 15 kHz is used in the NR system, a time period (e.g. length) of one symbol (e.g. OFDM symbol) may be 66.7 μs. When a subcarrier spacing of 30 kHz is used in the NR system, a time period of one symbol (e.g. OFDM symbol) may be 33.3 μs. In the following exemplary embodiments, a symbol may mean an OFDM symbol. That is, a time period of one symbol may be twice or more than a time period required for the ACG operation.

For sidelink communication, it may be necessary to transmit a data channel for data transmission and a control channel including scheduling information for data resource allocation. In sidelink communication, the data channel may be a physical sidelink shared channel (PSSCH), and the control channel may be a physical sidelink control channel (PSCCH). The data channel and the control channel may be multiplexed in a resource domain (e.g. time and frequency resource domains).

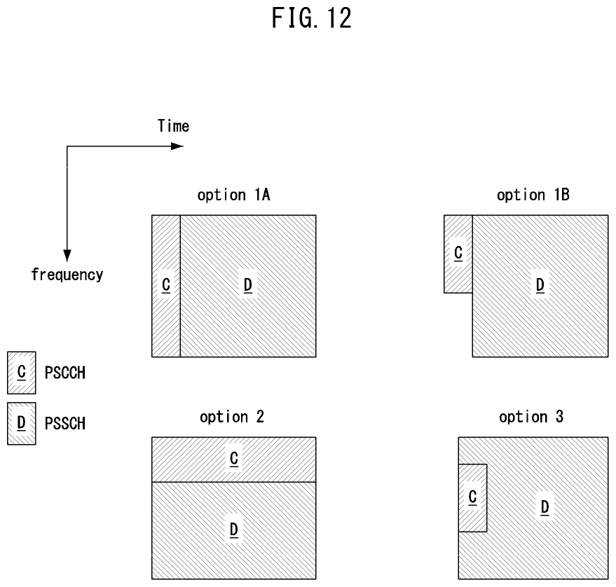

FIG. 12 is a conceptual diagram illustrating exemplary embodiments of a method for multiplexing a control channel and a data channel in sidelink communication.

Referring to FIG. 12, sidelink communication may support an option 1A, an option 1B, an option 2, and an option 3. When the option 1A and/or the option 1B is supported, a control channel and a data channel may be multiplexed in the time domain. When the option 2 is supported, a control channel and a data channel may be multiplexed in the frequency domain. When the option 3 is supported, a control channel and a data channel may be multiplexed in the time and frequency domains. The sidelink communication may basically support the option 3.

In the sidelink communication (e.g. NR-V2X sidelink communication), a basic unit of resource configuration may be a subchannel. The subchannel may be defined with time and frequency resources. For example, the subchannel may be composed of a plurality of symbols (e.g. OFDM symbols) in the time domain, and may be composed of a plurality of resource blocks (RBs) in the frequency domain. The subchannel may be referred to as an RB set. In the subchannel, a data channel and a control channel may be multiplexed based on the option 3.

In the sidelink communication (e.g. NR-V2X sidelink communication), transmission resources may be allocated based on a mode 1 or a mode 2. When the mode 1 is used, a base station may allocate sidelink resource(s) for data transmission within a resource pool to a transmitting terminal, and the transmitting terminal may transmit data to a receiving terminal using the sidelink resource(s) allocated by the base station. Here, the transmitting terminal may be a terminal that transmits data in sidelink communication, and the receiving terminal may be a terminal that receives the data in sidelink communication.

When the mode 2 is used, a transmitting terminal may autonomously select sidelink resource(s) to be used for data transmission by performing a resource sensing operation and/or a resource selection operation within a resource pool. The base station may configure the resource pool for the mode 1 and the resource pool for the mode 2 to the terminal(s). The resource pool for the mode 1 may be configured independently from the resource pool for the mode 2. Alternatively, a common resource pool may be configured for the mode 1 and the mode 2.

When the mode 1 is used, the base station may schedule a resource used for sidelink data transmission to the transmitting terminal, and the transmitting terminal may transmit sidelink data to the receiving terminal by using the resource scheduled by the base station. Therefore, a resource conflict between terminals may be prevented. When the mode 2 is used, the transmitting terminal may select an arbitrary resource by performing a resource sensing operation and/or resource selection operation, and may transmit sidelink data by using the selected arbitrary resource. Since the above-described procedure is performed based on an individual resource sensing operation and/or resource selection operation of each transmitting terminal, a conflict between selected resources may occur.

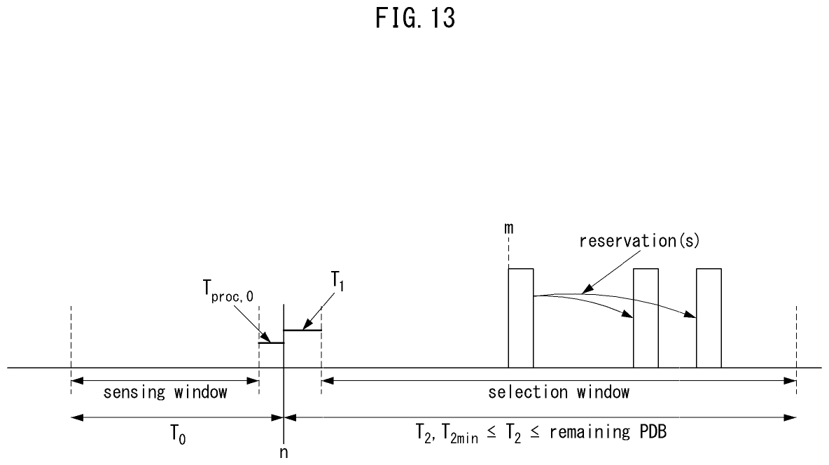

FIG. 13 is a conceptual diagram illustrating exemplary embodiments of a resource selection operation.

Referring to FIG. 13, a terminal (e.g. transmitting terminal) may perform a resource sensing operation within a sensing window, and may perform a resource selection operation on resource(s) (e.g. candidate resource(s)) sensed within the selection window. When the resource selection operation is triggered at a time n, the terminal may select suitable resource(s) within the selection window (e.g. a period from a time n+T₁ to a time n+T₂) based on a result of the sensing within the sensing window (e.g. a period from a time n−T₀ to a time n−T_{proc,0}).

Based on the result of the resource sensing operation, the terminal may exclude candidate resource(s) that do not satisfy a condition within the selection window. In other words, the terminal may determine the remaining candidate resources excluding the candidate resource(s) that are not suitable from all candidate resources. When a ratio of the remaining candidate resources among all resources within the selection window is less than a reference ratio, the terminal may relax the condition for excluding the candidate resource(s). For example, the terminal may increase a reference signal received power (RSRP) threshold, which is the condition for excluding candidate resource(s), by 3 dB. Thereafter, the terminal may perform the resource selection operation again. The reference ratio may be preset to one of 20%, 35%, or 50% for each priority. When the ratio of the remaining candidate resources is greater than or equal to the reference ratio, the terminal may randomly select final resource(s) to be used for SL transmission among the remaining candidate resources. The terminal may perform SL transmission using the final resource(s).

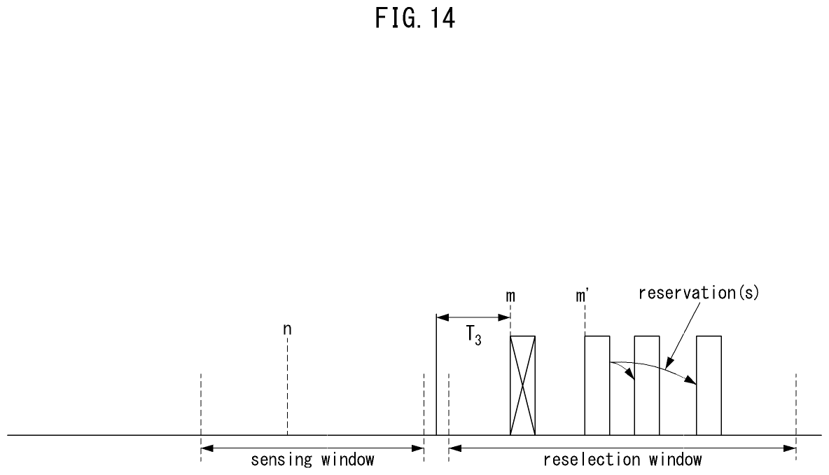

FIG. 14 is a conceptual diagram illustrating exemplary embodiments of a resource reselection operation.

Referring to FIG. 14, after the resource selection operation, the terminal may perform a resource reselection operation in consideration of aperiodic data transmission or the like. After performing the operations shown in FIG. 13, the terminal may perform the resource reselection operation by additionally considering a result of sensing at a time m−T₃ before actual SL transmission. The resource reselection operation may be performed within a reselection window. The terminal may further determine suitability of resource(s) reserved at the time m. When it is determined that the resource(s) reserved in the time m is suitable, the terminal may perform SL transmission using the reserved resource(s). When it is determined that the resource(s) reserved at the time m is not suitable, the terminal may reselect resource(s) for SL transmission and perform SL transmission using the reselected resource(s).

When an independent SL carrier is not configured for SL communication, some UL resources among UL resources may be configured as SL resources by an SL resource pool configuration procedure. A bitmap may be repeatedly applied to the remaining slot(s) excluding slot(s) in which at least X or more UL symbols are not configured and slot(s) in which a sidelink(S)-SSB is transmitted among slots within a specific period. X may be a natural number. The bitmap may indicate slot(s) used as SL resources. For example, slot(s) corresponding to bit(s) set to 1 among bits in the bitmap may be used as SL resources.

A case in which a 15 kHz subcarrier spacing (SCS) is applied and X or more UL symbols are configured in all slots may be assumed. When there are 10240 slots available within a direct frame number (DFN), a transmission periodicity of the S-SSB is 160 ms, and there are 2 slots used for S-SSB transmission in each S-SSB transmission period, the number of slots used for S-SSB transmission within a DFN may be 128. A bitmap for configuring SL time resources may include 10 bits. When the bitmap (e.g. bitmap including 10 bits) is repeatedly applied to the remaining 10112 slots excluding 128 slots used for S-SSB transmission among 10240 slots, there may be two slots (e.g. reserved slots) to which the bitmap is not applied. It may be necessary to exclude the two reserved slots. When excluding the two reserved slots from 10112 slots, 10110 slots may remain. The bitmap (e.g. bitmap including 10 bits) may be repeatedly applied 1011 times to 10110 slots. When the bitmap is set to ‘1111000000’ and slots corresponding to bits set to 1 are used as SL resources, 4044 slots may be configured as SL resources within the DFN. In other words, 4044 slots among 10240 slots may be used for SL communication by configuring the SL resource pool.

The sidelink communication system supporting Release-16 may be designed for terminals (e.g. vehicle-mounted terminals, vehicle UEs (V-UEs)) that do not have restrictions on battery capacity. Therefore, a power saving issue may not be greatly considered in resource sensing/selection operations for such the terminals. However, in order to perform sidelink communication with terminals having restrictions on battery capacity in the sidelink communication system supporting Release-17 (e.g. a terminal carried by a pedestrian, a terminal mounted on a bicycle, a terminal mounted on a motorcycle, a pedestrian UE (P-UE)), power saving methods will be required. In the present disclosure, a ‘V-UE’ may refer to a terminal that has no significant restrictions on battery capacity, a ‘P-UE’ may refer to a terminal with restrictions on battery capacity, and a ‘resource sensing/selection operation’ may refer to a resource sensing operation and/or a resource selection operation. The resource sensing operation may refer to a partial sensing operation or a full sensing operation. The resource selection operation may refer to a random selection operation. In addition, in the present disclosure, an ‘operation of a terminal’ may be interpreted as an ‘operation of a V-UE’ and/or ‘operation of a P-UE’.

For power saving in the LTE V2X, a partial sensing operation and/or a random selection operation has been introduced. When the partial sensing operation is supported, the terminal may perform resource sensing operations in partial periods instead of an entire period within a sensing window, and may select a resource based on a result of the partial sensing operation. According to such the operation, power consumption of the terminal may be reduced.

In the Release-14 LTE V2X, only periodic data transmission and reception operations may be possible. In the Release-14 LTE V2X, the terminal may arbitrarily select candidate slots within a resource selection period (e.g. selection window) in consideration of a preset minimum number, and perform a partial sensing operation in consideration of a periodicity of k×100 ms. k may be signaled by a bitmap (e.g. bitmap including 10 bits). k may be determined according to a position of a bit included in the bitmap. For example, 10 bits included in the bitmap may respectively correspond to values from 1 to 10 from the MSB, and the periodicity may be determined based on a value corresponding to a bit set to 1. The value corresponding to the bit set to 1 may be k.

When the MSB is set to 1 in the bitmap, k may be 1. In this case, the terminal may perform a partial sensing operation in consideration of a periodicity of 100 ms (=1×100 ms). When a bit next to the MSB in the bitmap is set to 1, k may be 2. In this case, the terminal may perform a partial sensing operation in consideration of a periodicity of 200 ms (=2×100 ms). When the LSB is set to 1 in the bitmap, k may be 10. In this case, the terminal may perform a partial sensing operation in consideration of a periodicity of 1000 ms (=10×100 ms).

In the Release-14 LTE V2X, the periodicity (e.g. the periodicity of partial sensing operation) may be set to 20 ms or 50 ms. A periodicity of 20 ms or 50 ms may not be supported in a resource pool for a P-UE. In the NR communication system, a shorter periodicity may be supported in addition to {0, 100 ms, 200 ms, . . . , 1000 ms}. The short periodicity may be {1 ms, 2 ms, . . . , 99 ms}. Up to 16 periodicities may be selected from the resource pool, and the selected periodicities may be preconfigured to the terminal. The terminal may perform the resource sensing operation and/or the resource (re)selection operation using one or more of the configured periodicities. When a random selection operation is supported, the terminal may randomly select a resource without performing a resource sensing operation. Alternatively, the random selection operation may be performed together with the resource sensing operation. For example, the terminal may determine resources by performing the resource sensing operation, and may select resource(s) by performing the random selection operation within the determined resources.

In the LTE V2X supporting Release-14, a resource pool in which the partial sensing operation and/or random selection operation can be performed may be configured independently of a resource pool in which the full sensing operation can be performed. A resource pool capable of performing the random selection operation, a resource pool capable of performing the partial sensing operation, and a resource pool capable of performing the full sensing operation may be independently configured. In other words, a random selection operation, a partial sensing operation, or both a random selection operation and a partial sensing operation may be configured for each resource pool. When both a random selection operation and a partial sensing operation are configured for a resource pool, the terminal may select one operation among the random selection operation and the partial sensing operation, select a resource by performing the selected operation, and use the selected resource to perform SL communication.

In the LTE V2X supporting Release-14, sidelink (SL) data may be periodically transmitted based on a broadcast scheme. In the NR communication system, SL data may be transmitted based on a broadcast scheme, multicast scheme, groupcast scheme, or unicast scheme. In addition, in the NR communication system, SL data may be transmitted periodically or aperiodically. A transmitting terminal may transmit SL data to a receiving terminal, and the receiving terminal may transmit an HARQ feedback (e.g. acknowledgement (ACK) or negative ACK (NACK)) for the SL data to the transmitting terminal on a PSFCH. In the present disclosure, a transmitting terminal may refer to a terminal transmitting SL data, and a receiving terminal may refer to a terminal receiving the SL data.

A terminal having reduced capability (hereinafter, referred to as ‘RedCap terminal’) may operate in a specific usage environment. The capability of the RedCap terminal may be lower than capability of a new radio (NR) normal terminal, and may be higher than those of an LTE-machine type communication (LTE-MTC) terminal, a narrow band (NB)-Internet of things (IoT) terminal, and a low power wide area (LPWA) terminal. For example, a terminal (e.g. surveillance camera) requiring a high data rate and not high latency condition and/or a terminal (e.g. wearable device) requiring a non-high data rate, high latency condition, and high reliability may exist. In order to support the above-described terminals, the maximum carrier bandwidth in FR1 may be reduced from 100 MHz to 20 MHZ, and the maximum carrier bandwidth in FR2 may be reduced from 400 MHz to 100 MHz. The number of reception antennas of the RedCap terminal may be smaller than the number of reception antennas of the NR normal terminal. When the carrier bandwidth and the number of reception antennas are reduced, reception performance at the RedCap terminal may decrease, and accordingly, the coverage of the RedCap terminal may decrease.

The communication system (e.g. NR system) may operate in a frequency band higher than a 52.6 GHz frequency band. As a frequency of the frequency band in which the communication system operates increases, a frequency offset error and a phase noise may increase. The use of a large SCS may be necessary for robust operations in such a environment. In an FR2 band, a 60 kHz SCS and/or a 120 kHz SCS may be supported, and a 480 kHz SCS and/or a 960 kHz SCS may be additionally supported. In addition, design of physical layer signals and channels and physical layer procedures according to the new SCSs may be required. Regarding an initial access procedure, 120 kHz SSBs and/or 240 kHz SSBs may be supported in an FR2 band, and 480 kHz SSBs and/or 960 kHz SSBs may be additionally supported. Here, the 120 kHz SSB may refer to an SSB transmitted in a radio resource to which the 120 kHz SCS is applied, and the 240 kHz SSB may refer to an SSB transmitted in a radio resource to which the 240 kHz SCS is applied. A method for configuring an initial BWP and an SSB burst set pattern for supporting the new SCSs may be required.

In the Release-18, techniques for carrier aggregation (CA) for improving a data transmission rate in sidelink, supports for operations in an unlicensed spectrum, performance enhancement in an FR2 licensed spectrum, and/or co-channel coexistence between LTE SL and NR SL may be discussed.

In a communication system supporting CA, data (e.g. data unit) may be transmitted through a plurality of component carriers (CCs). Different data units may be transmitted through a plurality of CCs. In this case, a transmission rate of the data (e.g. data units) can be improved. The same data may be transmitted through a plurality of CCs. In this case, reliability of data reception can be improved. LTE SL communication and/or NR SL communication may support CA (e.g. CA operations).

### Resource Configuration and Scheduling

In the mode 1 (e.g. SL mode 1), SL resources may be scheduled by a base station. The base station may transmit a DCI for scheduling SL communication to a terminal. In the presence disclosure, a DCI for scheduling SL communication may be referred to as SL DCI. The terminal may receive the SL DCI from the base station, generate an SCI based on information element(s) included in the SL DCI, and perform SL communication with other terminals by transmitting the SCI. In an SL CA environment, the base station may generate an SL DCI including indication information to indicate specific CC(s) (e.g. one or more CCs) among a plurality of CCs, and transmit the SL DCI to the terminal. SL communication may be performed in the specific CC(s) indicated by the SL DCI among the plurality of CCs. In other words, scheduling information included in the SL DCI may be applied to the specific CC(s) indicated by the SL DCI. In the present disclosure, the SL CA environment may be an environment in which SL CA operations are supported.

The indication information for indicating the specific CC(s) may be configured as CC index (ices) and/or a bitmap. In the present disclosure, the indication information for indicating the specific CC(s) may be referred to as CC indication information. The number of bits included in the bitmap may be equal to the number of the plurality of CCs. In other words, each bit included in the bitmap may correspond to one CC. The terminal may receive the SL DCI from the base station and identify information elements (e.g. scheduling information, CC indication information) included in the SL DCI. The terminal may generate an SCI for SL communication in the specific CC(s) indicated by the SL DCI based on the scheduling information included in the SL DCI. The terminal may transmit the SCI (e.g. SCI generated based on the SL DCI) to another terminal and perform SL communication with the another terminal based on the SCI. The SL communication with the another terminal may be performed in the specific CC(s) indicated by the SL DCI. The SCI may include CC indication information. Alternatively, the SCI may not include CC indication information.

In the mode 2 (e.g. SL mode 2), a terminal may select SL resource(s) by performing a resource sensing operation and/or resource selection operation, and perform SL communication with other terminals using the selected SL resource(s). In the mode 2, the terminal may select SL resource(s) for each CC by independently performing a resource sensing operation and/or resource selection operation in each CC, and use the selected SL resource(s) to perform SL communication with other terminals in each CC. In the mode 2, an SCI may not include CC indication information. In the mode 2, when the terminal performs SL communication with other terminals through cross-carrier scheduling, an SCI may include CC indication information.

In the SL CA environment, SL resource(s) may be configured independently for each CC. All available resources in an intelligent transport system (ITS) band may be used for SL communication. Some uplink resources may be configured in a band other than the ITS band, and the terminal may use the some uplink resources for SL communication. In this case, for smooth configuration and/or scheduling of SL resource(s), it may be preferable to align resource configurations between multiple CCs (e.g. all CCs in which SL communication is performed). For example, when configuring some of uplink resources as SL resource(s) for SL transmission including S-SSB transmission, in the multiple CCs (e.g. all CCs), SL resource(s) (e.g. all SL resources) including PSFCH resource(s) may be configured based on the same time pattern.

For example, a start time (e.g. start time point) and/or an end time (e.g. end time point) of SL resources in a first CC may be the same as a start time (e.g. start time point) and/or an end time (e.g. end time point) of SL resources in a second CC. The time pattern may refer to locations where time resources are configured (e.g. allocated) in the time domain. A terminal (e.g. transmitting terminal and/or receiving terminal) may align SL resources in the CCs. The transmitting terminal may align SL resources in the CCs based on SL resource configuration information received from the base station. The receiving terminal may align SL resources in the CCs based on SL resource configuration information received from the base station and/or transmitting terminal. The SL resource configuration information may be transmitted to terminals (e.g. transmitting terminal and/or receiving terminal) through signaling. The SL resource configuration information may refer to time pattern information.

SL resource(s) (e.g. all SL resources) including PSFCH resource(s) in a plurality of CCs (e.g. all CCs) within the ITS band may be configured based on the same time pattern. SL resources having the same pattern (e.g. the same time pattern) may be configured in the plurality of CCs (e.g. all CCs). In this case, SL communication can be scheduled efficiently. SL resource(s) may be configured (e.g. allocated) in the plurality of CCs (e.g. all CCs) by one signaling (e.g. one signaling message). Therefore, signaling overhead for configuring SL resource(s) can be reduced. SL resources having the same pattern (e.g. the same time pattern) in the plurality of CCs (e.g. all CCs) may include at least one of a start symbol, end symbol, symbol length (e.g. number of symbols), SL resource length, cyclic prefix (CP) length, PSFCH periodicity, or S-SSB periodicity. For example, at least one of the start symbol, end symbol, symbol length (e.g., number of symbols), SL resource length, CP length, PSFCH periodicity, or S-SSB periodicity may be configured identically in the plurality of CCs.

The base station and/or terminal may transmit SL resource configuration information (e.g. configuration information of SL resources having the same time pattern, configuration information of aligned SL resources, time pattern information) to a terminal (e.g. another terminal) through signaling in a plurality of CCs (e.g. all CCs). In the present disclosure, signaling may be at least one of SI signaling (e.g. transmission of SIB and/or MIB), RRC signaling (e.g. transmission of RRC parameter(s) and/or higher layer parameter(s)), MAC CE signaling, or PHY signaling (e.g. transmission of DCI, UCI, and/or SCI). The RRC signaling may include UE-specific RRC signaling and/or PC5-RRC signaling. It may be difficult to receive signaling information (e.g. signaling message) in an out-of-coverage environment, and in this case, information (e.g. SL resource configuration information) preconfigured in the terminal may be used.

### Resource Selection and Multiple Transmissions/Receptions

In the mode 1 (e.g. SL mode 1), a base station may select resource(s) for SL communication. In the mode 2 (e.g. SL mode 2), a terminal may select resource(s) by performing a resource sensing operation and/or resource selection operation. In the mode 2, SL CA operations may be supported (e.g. performed). In this case, the terminal may select resource(s) by independently performing a resource sensing operation and/or resource selection operation for each CC, and may perform SL communication using the resource(s) selected in each CC.

The SL communication may be performed based on a half-duplex mode. In the half-duplex mode, SL reception operations may not be performed while an SL signal and/or channel (e.g. SL data) is being transmitted, and SL transmission operations may not be performed while an SL signal and/or channel is being received. When SL transmissions are performed in a plurality of CCs, the cases in which an SL signal and/or channel is not received due to frequent SL transmissions may increase. The cases where SL transmission is abandoned (e.g. dropped) due to SL receptions in multiple CCs may increase. In the SL CA environment, efficient resource selection operations may be required considering the characteristics of SL communication.

When SL transmissions are performed in a plurality of CCs, the terminal may independently perform a resource sensing operation in each of the CCs and perform a resource selection operation based on a result of the resource sensing operation. In this case, candidate resource(s) located in a larger number of CCs may be preferentially selected from among candidate resources for data transmission (e.g. simultaneous transmissions) in consideration of the half-duplex characteristics of SL communication.

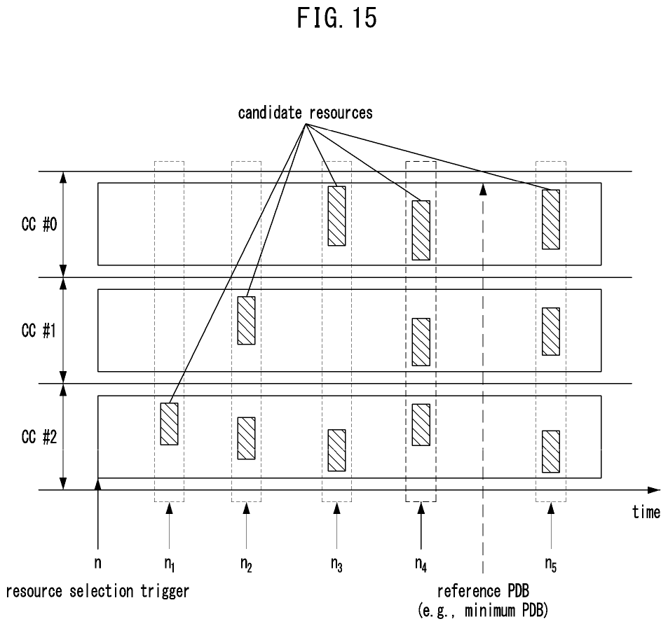

FIG. 15 is a conceptual diagram illustrating exemplary embodiments of a resource selection operation in an SL CA environment.

Referring to FIG. 15, a terminal may perform a resource selection operation based on a result of a resource sensing operation in each of CCs (e.g. CC #0, CC #1, and CC #2). Transmission of data (e.g. SL data) may be required in all the CCs (e.g. CC #0, CC #1, CC #2). Candidate resources may exist only in some CCs at times n₁, n₂, and n₃. For example, at the time n₁, candidate resources may be located only in CC #2. At the time n₂, candidate resources may be located only in CC #1 and CC #2, and at the time n₃, candidate resources may be located only in CC #0 and CC #2. At the time n₄, candidate resources may exist in all the CCs (e.g. CC #0, CC #1, CC #2). Therefore, the terminal may preferentially select candidate resources at the time n₄. The terminal may select candidate resources within a range that satisfies a packet delay budget (PDB) threshold for data (e.g. all data units). The PDB threshold may be configured as the minimum PDB value (PDBₘᵢₙ) among PDB values of the data units. At a time n₅, candidate resources exist in all the CCs (e.g. CC #0, CC #1, CC #2), but since the time n₅ is a time exceeding the PDB threshold (e.g. minimum PDB value), the terminal may not select candidate resources at the time n₅.

When considering the PDB threshold (e.g. PDBₘᵢₙ) to select candidate resources, candidate resources existing in all the CCs may not satisfy the PDB threshold. In this case, candidate resources for data transmission may not be selected. In the above-described situation, considering the PDB threshold and/or priorities, candidate resources located in the most CCs among candidate resources may be selected. Candidate resources that satisfy the PDB threshold may exist in all the CCs. Candidate resources that satisfy the PDB threshold in all the CCs within a first time period may be defined as a first candidate resource set. Candidate resources that satisfy the PDB threshold in all the CCs within a second time period may be defined as a second candidate resource set. When a plurality of candidate resource sets exist, the terminal may randomly select at least one candidate resource set from among the plurality of candidate resource sets.

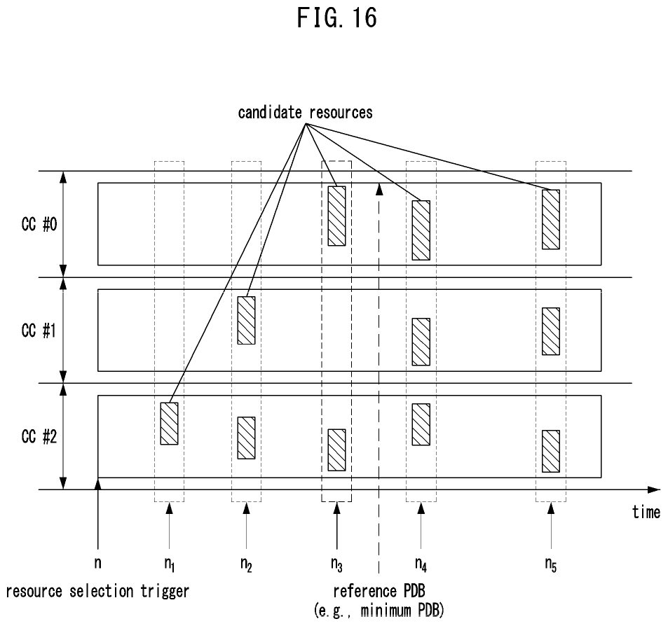

FIG. 16 is a conceptual diagram illustrating exemplary embodiments of a resource selection operation in an SL CA environment.

Referring to FIG. 16, candidate resources (e.g. candidate resources at the time n₄, candidate resources at the time n₅) existing in all CCs (e.g. CC #0, CC #1, CC #2) may not satisfy the PDB threshold. In this case, the terminal may select candidate resources located in the most CCs from among the candidate resources. At the time n₂, candidate resources may be located in two CCs (e.g. CC #1 and CC #2), and at the time n₃, candidate resources may be located in two CCs (e.g. CC #0 and CC #2). If a priority of data to be transmitted in CC #0 is higher than a priority of data to be transmitted in CC #1, the terminal may select candidate resources located at the time n₃. When multiple priorities exist, the terminal may compare the highest priorities at each time point, and if the highest priorities are the same, the terminal may compare the next priorities in order. The terminal may perform a resource selection operation based on a result of comparing the priorities.

The terminal may perform the resource selection operation by considering RF requirements in addition to the PDB threshold (e.g. PDB condition) and/or priorities. SL transmission using a plurality of CCs may exceed capability (e.g. transmission capability) of the terminal. In this case, the terminal may not be able to perform SL transmission in some CCs. Considering the above-described situation, the terminal may select resources from m CCs within its capability. m may be a natural number. The terminal may perform the resource selection operation considering a TX/RX switching time. A TX/RX switching time of the terminal in the SL CA environment may be longer than a TX/RX switching time of the terminal in a single CC environment. In a communication system supporting LTE SL intra-band CA operations, the TX/RX switching time of the terminal may be 200 μs. The single CC environment may be an environment that supports single CC operations.

The TX/RX switching operation may not be completed within a gap period (e.g. gap symbol period) configured as one symbol. A resource selection operation considering the above-described situation may be required. For example, the terminal may not select a slot immediately following an SL reception slot as an SL transmission slot. The terminal may select a slot after a sufficient TX/RX switching time (e.g. time corresponding to one slot) from an SL reception slot as an SL transmission slot. The SL reception slot may be a slot in which an SL reception operation is performed. The SL transmission slot may be a slot in which an SL transmission operation is performed.

The terminal may select candidate resources capable of SL transmission from a plurality of CCs. The terminal may perform SL transmission using candidate resource(s) that satisfy the RF requirement(s) among the selected candidate resources. If the capability of the terminal does not support SL transmission using a plurality of CCs, the terminal may abandon (e.g. drop) SL transmission(s) (e.g. data transmission(s)) in some CCs among the plurality of CCs. If a transmission power required for SL transmission(s) using a plurality of CCs exceeds the maximum transmission power of the terminal, the terminal may abandon (e.g. drop) SL transmission(s) (e.g. data transmission(s)) in some CCs among the plurality of CCs.

Due to a power spectral density (PSD) imbalance, adjacent channel interference, etc., the terminal may abandon (e.g. drop) SL transmission(s) (e.g. data transmission(s)) in some CCs among a plurality of CCs. The terminal may first abandon SL transmission in a specific CC based on a preconfigured condition. For example, the terminal may first abandon SL transmission in a CC with a low priority among a plurality of CCs. If the CCs have the same priority, the terminal may abandon SL transmission in a specific CC by considering additional condition(s) (e.g. transport block size (TBS), number of retransmissions). The terminal may select the specific CC in which SL transmission is abandoned, in terms of implementation.

The terminal may perform the resource selection operation considering the half-duplex characteristics of SL communication. The terminal may not select a resource in which data is scheduled to be received as a candidate resource. In other words, a resource in which data is scheduled to be received may be excluded from SL communication. However, in the SL CA environment, if data transmission is possible in more CCs than CC(s) in which data is scheduled to be received, the terminal may select a resource in which data is scheduled to be received as a candidate resource. In other words, a resource in which data is scheduled to be received may not be excluded from SL communication.

The terminal may transmit and receive data (e.g. SL data) considering the half-duplex characteristics of SL communication. If SL transmission resource(s) and SL reception resource(s) overlap in a plurality of CCs within the same time period, the terminal may preferentially select an operation performed in a larger number of CCs. For example, if there are more CCs in which SL transmission operations are performed than CCs in which SL reception operations are performed, the terminal may preferentially perform the SL transmission operations in a plurality of CCs. If there are more CCs in which SL reception operations are performed than CCs in which SL transmission operations are performed, the terminal may preferentially perform the SL reception operations in a plurality of CCs.

As another method, the terminal may preferentially perform operations with a high priority among the SL transmission operations and the SL reception operations. The terminal may compare the highest priority of the SL transmission operations with the highest priority of the SL reception operations, and perform operations with a higher priority (e.g. SL transmission operations or SL reception operations) in a plurality of CCs. If the highest priority of the SL transmission operations and the highest priority of the SL reception operations are the same, the terminal may compare a next priority of the SL transmission operations (e.g. the next priority of the highest priority) and a next priority of the SL reception operations, and perform operations with a higher priority (e.g. SL transmission operations or SL reception operations) in a plurality of CCs.

### Synchronization

In the SL CA environment, synchronization between a plurality of CCs may be important. In order to acquire synchronization between a plurality of CCs, a terminal may transmit S-SSB(s) in each of the CCs. A synchronization procedure between a plurality of CCs may be performed based on S-SSB(s). To transmit S-SSB(s) in each of the CCs, separate resources for S-SSB transmission may be configured. SL data may not be able to be transmitted or received in resources configured for S-SSB transmission. Therefore, resource efficiency in SL communication may decrease. Since the terminal performs an S-SSB reception operation in each CC, complexity and/or power consumption of the terminal may increase. In order to solve the above-described problems, S-SSB(s) may be transmitted in specific CC(s) (e.g. synchronization(S)-CC(s), reference CC(s), or synchronization reference CC(s)) among a plurality of CCs. Synchronization in CC(s) other than the S-CC(s) among the plurality of CCs may be acquired based on the S-SSB(s) transmitted in the S-CC(s). For example, the terminal may configure (e.g. adjust) synchronization for all CCs based on the S-SSB(s) received in the S-CC(s). The S-CC(s) may be indicated (e.g. configured) by signaling. For example, the base station and/or terminal may transmit a signaling message indicating the S-CC(s) to the terminal (e.g. another terminal).

In the SL CA environment, a specific terminal may perform SL communication using a single CC. When S-SSB(s) are transmitted in the S-CC and the single CC is not the S-CC, the terminal operating in the single CC may not be able to acquire synchronization. To solve the above-described problem, S-SSB(s) may be transmitted in each of a plurality of CCs (e.g. all CCs), and the terminal (e.g. receiving terminal) may acquire synchronization of the plurality of CCs based on S-SSB(s) received in the S-CC. Transmission periodicities of S-SSB may be set to be the same across the plurality of CCs (e.g. all CCs). The above-described procedure (e.g. CA synchronization procedure) may be applied to intra-band CA. The base station may transmit information indicating that the CA synchronization procedure is applied in the intra-band CA to terminals (e.g. transmitting terminal and/or receiving terminal) through signaling. The terminals may identify that the CA synchronization procedure is applied in the intra-band CA based on the information received from the base station. Alternatively, the transmitting terminal may transmit information indicating that the CA synchronization procedure is applied in the intra-band CA to the receiving terminal through signaling. The receiving terminal may identify that the CA synchronization procedure is applied in the intra-band CA based on the information received from the transmitting terminal.

The information indicating that the CA synchronization procedure is applied in the intra-band CA may be included in system information, UE-specific RRC message, PC5-RRC message, and/or S-SSB (e.g. S-PBCH in S-SSB). The S-CC may be a CC with the lowest index or a CC with the highest index among the plurality of CCs. The base station may transmit information indicating the S-CC to terminals (e.g. transmitting terminal and/or receiving terminal) through signaling. The terminals may identify the S-CC based on the information received from the base station. Alternatively, the transmitting terminal may transmit information indicating the S-CC to the receiving terminal through signaling. The receiving terminal may identify the S-CC based on the information received from the transmitting terminal. The information indicating the S-CC may be included in system information, UE-specific RRC message, PC5-RRC message, and/or S-SSB (e.g. S-PBCH in S-SSB).

The S-CC may be configured implicitly. For example, a CC in which an S-SSB with the highest priority (e.g. S-SSB associated with a synchronization reference with the highest priority) is transmitted among a plurality of CCs may be considered as the S-CC. If priorities of a plurality of synchronization references are the same, the terminal may select an arbitrary synchronization reference among the plurality of synchronization references having the same priority, and may determine a CC associated with the selected synchronization reference (e.g. CC in which an S-SSB associated with the selected synchronization reference is transmitted) as the S-CC. Alternatively, if priorities of a plurality of synchronization references are the same, the terminal may select one synchronization reference among the plurality of synchronization references having the same priority by considering additional condition(s), and may determine a CC associated with the selected synchronization reference (e.g. CC in which an S-SSB associated with the selected synchronization reference is transmitted) as the S-CC. For example, among the plurality of synchronization references with the same priority, a synchronization reference of an S-SSB with a high RSRP may be selected preferentially.

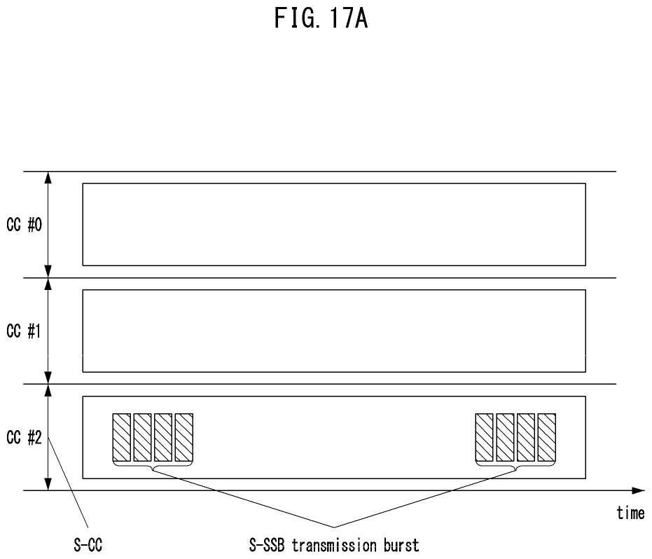

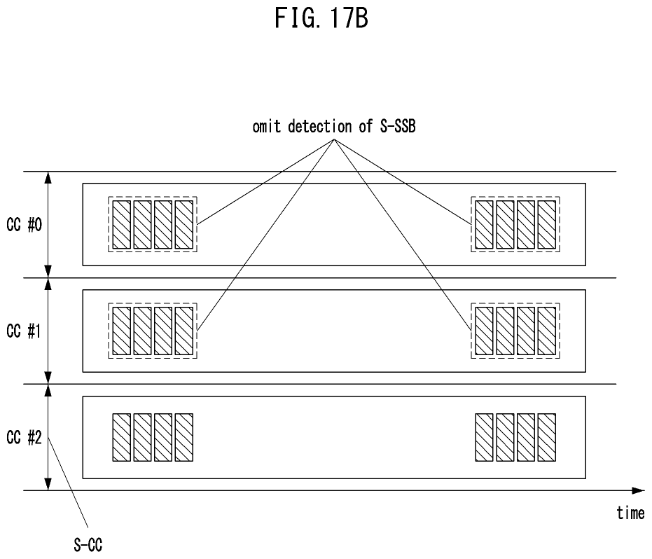

FIG. 17A is a conceptual diagram illustrating exemplary embodiments of a first synchronization method according to S-CC configuration in an SL CA environment, and FIG. 17B is a conceptual diagram illustrating exemplary embodiments of a second synchronization method according to S-CC configuration in an SL CA environment.

Referring to FIG. 17A, the CC #2 may be configured as an S-CC. The transmitting terminal may transmit S-SSB(s) in the S-CC. The receiving terminal may receive the S-SSB(s) in the S-CC and acquire synchronization in all CCs (e.g. CC #0, CC #1, CC #2) based on the S-SSB.

Referring to FIG. 17B, the CC #2 may be configured as an S-CC. The transmitting terminal may transmit S-SSBs in all CCs (e.g. CC #0, CC #1, CC #2). The receiving terminal may receive the S-SSB in the S-CC and acquire synchronization in all CCs (e.g. CC #0, CC #1, CC #2) based on the S-SSB. The receiving terminal may not perform S-SSB reception operations (e.g. detection operations) in CCs (e.g. CC #0, CC #1) other than the S-CC. By omitting the S-SSB reception operations in other CCs, power consumption of the receiving terminal can be reduced.

### Power Control

In NR SL communication, a plurality of SL transmissions may be performed through a plurality of CCs. A terminal may not be able to perform specific SL transmission(s) depending on its capability (e.g. limitation on the maximum number of simultaneous transmissions, limitation on the maximum transmission power). The terminal may select some SL transmission(s) based on priorities among the plurality of SL transmissions, and perform the some selected SL transmission(s). The terminal may perform the remaining SL transmission(s) (e.g. the remaining SL transmission(s) excluding the some selected SL transmission(s) among the plurality of SL transmissions) using a low transmission power within its capability. Alternatively, the terminal may abandon the remaining SL transmission(s) depending on its capability.

If SL transmissions have the same priority, the terminal may select some SL transmission(s) among the SL transmissions based on other condition(s). Other condition(s) may include at least one of the sizes of SL transmission resources, the sizes of SL data, or an SL transmission type (e.g. SL initial transmission or SL retransmission). The terminal may preferentially select an SL transmission with a larger SL transmission resource among the SL transmissions. The terminal may preferentially select an SL transmission with larger SL data among the SL transmissions. The terminal may preferentially select SL initial transmission among SL initial transmission and SL retransmission. The terminal may preferentially select SL retransmission among SL initial transmission and SL retransmission depending on a service type.

PSFCH resource configurations in a plurality of CCs may be different. In this case, the terminal may preferentially select CC(s) including PSFCH resource(s) among the plurality of CCs at a specific time. In terms of implementation, the terminal may preferentially select arbitrary CC(s) among the plurality of CCs. The above-described methods may be applied to SL transmissions using a plurality of CCs regardless of priorities. A transmission power of SL transmission(s) using the selected CC(s) may not change within slot(s). When PSFCH transmission(s) occur in some of the plurality of CCs, the total transmission power of the terminal may change due to the PSFCH transmission(s), but SL transmission in each of the plurality of CCs may not change within the slot(s).

SL communication may be performed in the unicast, groupcast, or broadcast scheme. The receiving terminal may transmit HARQ feedback information (e.g. ACK or NACK) for SL unicast transmission on a PSFCH. The receiving terminal may transmit HARQ feedback information (e.g. ACK or NACK) for SL groupcast transmission on a PSFCH. SL unicast transmission may be SL transmission performed in the unicast scheme. SL groupcast transmission may be SL transmission performed in the groupcast scheme. In the SL CA environment, a terminal (e.g. receiving terminal) may perform PSFCH transmission for each CC. PSFCH transmission in the SL CA environment may be performed identically to PSFCH transmission in the single CC environment.

The terminal may perform a plurality of PSFCH transmissions through a plurality of CCs. The terminal may perform PSFCH transmissions so that the maximum transmission power is not exceeded within the maximum number of PSFCH transmissions. If the number of the plurality of PSFCH transmissions in the plurality of CCs exceeds the maximum number of PSFCH transmissions, the terminal may sequentially abandon (e.g. drop) PSFCH transmissions with low priorities. If a transmission power for the plurality of PSFCH transmissions exceeds the maximum transmission power of the terminal, the terminal may perform PSFCH transmission(s) with high priorities within the maximum transmission power. The terminal may perform PSFCH transmission(s) with low priority using a reduced transmission power within its capability. Alternatively, the terminal may abandon (e.g. drop) the PSFCH transmission(s) with low priority depending on its capability.

The terminal may perform PSFCH transmission(s) by sequentially considering the maximum number of PSFCH transmissions and maximum transmission power. Alternatively, the terminal may perform PSFCH transmission(s) by considering the maximum number of PSFCH transmissions or maximum transmission power. The maximum number of PSFCH transmissions and/or maximum transmission power may be configured for each CC. In this case, the terminal may perform PSFCH transmission(s) by considering the maximum number of PSFCH transmissions and/or maximum transmission power for each CC. Alternatively, the maximum number of PSFCH transmissions and/or maximum transmission power may be set for the entire CCs. In this case, the terminal may perform PSFCH transmission(s) by considering the maximum number of PSFCH transmissions and/or maximum transmission power for the entire CCs.

The maximum number of PSFCH transmissions and maximum transmission power may be set for each CC, and the maximum number of PSFCH transmissions and maximum transmission power mat be considered sequentially. In addition, power control based on a DL path loss within a coverage of the base station may be configured. In the above-described situation, if the number of PSFCH transmissions that the terminal wishes to perform exceeds the maximum number of PSFCH transmissions for each CC, the terminal may preferentially select PSFCH transmission(s) with high priority. After considering the maximum number of PSFCH transmissions, the terminal may consider the maximum transmission power. If the transmission power for the terminal's PSFCH transmission(s) exceeds the maximum transmission power for each CC, the terminal may preferentially allocate a transmission power to PSFCH transmission(s) with high priority. The terminal may perform the PSFCH transmission(s) using the allocated transmission power. The terminal may perform the remaining PSFCH transmission(s) (e.g. PSFCH transmission(s) to which a transmission power was not allocated in the previous step) using a reduced transmission power within its capability. Alternatively, the terminal may abandon (e.g. drop) the remaining PSFCH transmission(s) depending on its capability.

Only some conditions among the maximum number of PSFCH transmissions and maximum transmission power may be considered. When the terminal is located outside the coverage of the base station, only some of the above-described conditions may be considered. In the above-described situation, if the number of PSFCH transmissions that the terminal wishes to perform exceeds the maximum number of PSFCH transmissions for each CC, the terminal may preferentially select PSFCH transmission(s) with high priority. The terminal may equally allocate transmission powers to the selected PSFCH transmission(s) by considering the maximum transmission power. The number of selected PSFCH transmission(s) may be less than or equal to the maximum number of PSFCH transmissions.

The above-described operations may be performed for each CC. Thereafter, considering the maximum number of PSFCH transmissions and maximum transmission power in the SL CA environment, if the total number of PSFCH transmissions in CCs exceeds the maximum number of PSFCH transmissions, the terminal may select some PSFCH transmission(s) among all PSFCH transmissions based on priorities. Thereafter, if a sum of the transmission powers of the selected PSFCH transmissions exceeds the maximum transmission power, the terminal may select one or more PSFCH transmissions among the some selected PSFCH transmissions based on priorities. The terminal may preferentially allocate a transmission power required for the one or more selected PSFCH transmissions. The terminal may allocate a reduced transmission power within its capability to the remaining PSFCH transmission(s) (e.g. the remaining PSFCH transmission(s) excluding the one or more PSFCH transmissions among the some selected PSFCH transmissions). The same reduced transmission power may be allocated to the remaining PSFCH transmission(s). Alternatively, the terminal may abandon the remaining PSFCH transmission(s) depending on its capability.

As another method, instead of comparing the priorities of all PSFCH transmissions in the CCs, the terminal may identify a representative PSFCH transmission with the highest priority in each of the CCs, and compare priorities of the representative PSFCH transmissions of the CCs. The terminal may identify a CC to which a representative PSFCH transmission with low priority belongs, and perform some PSFCH transmission(s) selected among PSFCH transmissions belonging to the identified CC by considering the maximum number of PSFCH transmissions and/or maximum transmission power. In other words, if a sum of PSFCH transmissions in CCs (e.g. all CCs) exceeds the maximum number of PSFCH transmissions in the SL CA environment, the terminal may compare prioritizes of the representative PSFCH transmissions with the highest priority in the respective CCs, and may exclude some or all PSFCH transmissions in a CC to which a representative PSFCH transmission with low priority belongs. In other words, the terminal may not perform some or all PSFCH transmissions in a CC to which the representative PSFCH transmission with low priority belongs.

If the sum of PSFCH transmission powers in CCs (e.g. all CCs) exceeds the maximum transmission power of the terminal, the terminal may compare the priorities of representative PSFCH transmissions with the highest priority in the respective CCs, and may perform PSFCH transmissions using a reduced transmission power in a CC to which a representative PSFCH transmission with low priority belongs. Alternatively, the terminal may abandon (e.g. drop) PSFCH transmissions in the CC to which the representative PSFCH transmission with low priority belongs. If the reduced transmission power is used, transmission powers of the PSFCH transmissions may be reduced equally. In the above-described exemplary embodiment, when the priorities of the representative PSFCH transmissions are the same, the terminal may sequentially compare priorities next to the priorities of the representative PSFCH transmissions. As another method, the number of PSFCH transmissions in each of the CCs may be different. For example, k PSFCH transmissions may be configured in a first CC, and p PSFCH transmissions may be configured in a second CC. Each of k and p may be a different natural number. The terminal may adjust transmission powers of PSFCH transmissions and/or abandon PSFCH transmissions, starting from a CC in which the smallest number of PSFCH transmissions are configured.

Considering the maximum number of PSFCH transmissions in each CC and the maximum number of PSFCH transmissions in the SL CA environment (e.g. all CCs), the terminal (or base station) may appropriately configure PSFCH transmissions for each CC. Alternatively, without considering the maximum number of PSFCH transmissions in the SL CA environment (e.g. all CCs), the terminal (or base station) may appropriately configure PSFCH transmissions for each CC by considering the maximum number of PSFCH transmissions in each CC. In this case, after the selection procedure for PSFCH transmissions in each CC, the terminal may not perform an additional selection procedure considering the maximum number of PSFCH transmissions in the SL CA environment (e.g. all CCs).

The maximum number of PSFCH transmissions in each CC may be set considering the maximum number of PSFCH transmissions in the SL CA environment (e.g. all CCs). In this case, the maximum number of PSFCH transmissions in each CC may not exceed the maximum number of PSFCH transmissions in the SL CA environment. The same number of PSFCH transmissions may be configured for each of the CCs. Alternatively, PSFCH transmissions may be configured independently for each CC considering a situation of each CC.

The maximum number of PSFCH transmissions and maximum transmission power may be set for the SL CA environment (e.g. all CCs). In this case, operations in each CC may be performed considering all CCs. If a sum of PSFCH transmissions in CCs exceeds the maximum number of PSFCH transmissions in the SL CA environment (e.g. all CCs), the terminal may select PSFCH transmission(s) considering priorities. If a sum of the transmission powers of the selected PSFCH transmissions exceeds the maximum transmission power of the terminal in the SL CA environment, the terminal may select PSFCH transmission(s) considering priorities. The terminal may perform the remaining PSFCH transmissions (e.g. unselected PSFCH transmissions) using a reduced transmission power within its capability. Alternatively, the terminal may abandon (e.g. drop) the remaining PSFCH transmissions depending on its capability.

PSFCH resources (e.g. PSFCH transmission periodicity) may be independently set for each CC. PSFCH resources may be configured differently in each CC. For example, PSFCH resources in a first CC may be different from PSFCH resources in a second CC. To easily manage transmission powers, PSFCH resources may be configured identically in all CCs. For example, PSFCH transmission periodicities (e.g. PSFCH periodicities) may be set equally in all CCs.

### Maximum Number of PSFCH Transmissions

The maximum number N_{max,PSFCH} of PSFCH transmissions may be defined depending on the capability of the terminal. The terminal may not be able to simultaneously perform PSFCH transmissions exceeding N_{max,PSFCH}. The capability of the terminal may be configured for each band as shown in Table 6 below. In power control for PSFCH transmission, if PSFCH transmissions in each of the CCs exceed N_{max,PSFCH}, the terminal may abandon (e.g. drop) some PSFCH transmission(s) according to priorities. When there is one CC in the band, the terminal may apply N_{max,PSFCH} set for each band to the CC belonging to the band, and perform power control based on N_{max,PSFCH}. In an intra-band CA environment where a plurality of CCs exist within one band, a method of applying N_{max,PSFCH} for each band to the plurality of CCs may be required.

TABLE 6

| | | | FDD − | FR1 − |
|---|---|---|---|---|
| | | | TDD | FR2 |
| Definition of parameters | Per- | M | DIFF | DIFF |
| psfch-FormatZeroSidelink-r16 | band | CY | N/A | N/A |
| psfch-FormatZeroSidelink-r16 may | | | | |
| indicate whether the UE supports | | | | |
| PSFCH format 0. When the UE supports | | | | |
| PSFCH format 0, psfch- | | | | |
| FormatZeroSidelink-r16 may indicate | | | | |
| support for capabilities, and | | | | |
| psfch-FormatZeroSidelink-r16 | | | | |
| may include parameters below. | | | | |
| The UE can transmit and receive NR | | | | |
| PSFCH format 0. | | | | |
| psfch-RxNumber: psfch-RxNumber may | | | | |
| indicate the number of PSFCHs (e.g. | | | | |
| PSFCH resources) that the UE can | | | | |
| receive in one slot. n5 may correspond | | | | |
| to 5, and n15 may correspond to 15. | | | | |
| psfch-TxNumber: psfch-TxNumber may | | | | |
| indicate the number of PSFCHs (e.g. | | | | |
| PSFCH resources) that the UE can | | | | |
| transmit in one slot. n4 may correspond | | | | |
| to 4, and n8 may correspond to 8. | | | | |
| When the UE supports at least one of sl- | | | | |
| Reception-r16 or sl- | | | | |
| TransmissionMode2-r16, the above- | | | | |
| described fields may be applicable. | | | | |
| Note: Configuration by NR Uu may not be | | | | |
| required. The configuration may be | | | | |
| supported in a band indicated by a | | | | |
| PC5 interface (e.g. a band with a | | | | |
| PC5 interface). | | | | |
| When the UE supports NR SL, support | | | | |
| of the above feature may be | | | | |
| mandatory. | | | | |

The terminal may equally apply N_{max,PSFCH} set for each band to a plurality of CCs within the band. N_{max,PSFCH} may be applied to each CC, and power control may be performed for each CC. Although N_{max,PSFCH} is set for each band, since N_{max,PSFCH} is applied to the plurality of CCs in the band, the maximum number of PSFCH transmissions (e.g. PSFCHs that can be transmitted) within the band may increase in proportion to the number of CCs (e.g. CCs in the band). For example, if the number of CCs in the band is N_{CC}, the maximum number of PSFCH transmissions in the band may be N_{CC}×N_{max,PSFCH}.

As another method, the terminal may divide and allocate N_{max,PSFCH} set for each band into the plurality of CCs. For example, if the number of CCs in the band is N_{CC}, the maximum number of PSFCH transmissions for each CC in the band may be defined as N_{max,PSFCH,CC} =N_{max,PSFCH}/N_{CC}. The maximum number of PSFCH transmission in each CC may be defined as

$${N}_{ma x , PSFCH , CC} = floor ( \frac{{N}_{ma x , PSFCH}}{{N}_{CC}} ) or {N}_{ma x , PSFCH , CC} = ceil ( \frac{{N}_{ma x , PSFCH}}{{N}_{CC}} ) .$$

The terminal may perform power control for each CC by considering the maximum number N_{max,PSFCH,CC} of PSFCH transmissions in each CC.

As another method, the base station and/or terminal may determine the maximum number of PSFCH transmissions by considering a situation at each CC rather than for each band. For example, the base station and/or terminal may define new UE capability parameters for each CC and perform configuration based on the new UE capability parameters for each CC. If there are N_{CC} CCs in the band, the base station and/or terminal may set N_{max,PSFCH,CC,k} (k=₀, . . . , N_{CC}-1) for each CC. The base station and/or the terminal may set N_{max,PSFCH,CC,k} so that a sum of PSFCH transmissions in all CCs does not exceed N_{max,PSFCH} for each band. For example, the base station and/or terminal may set N_{max,PSFCH,CC,k} based on Equation 1 below.

$${\sum }_{k = 0}^{{N}_{C C - 1}} {N}_{ma x , PSFCH , CC , k} \leq {N}_{ma x , PSFCH} ) \qquad [ Equation 1 ]$$

The terminal may perform power control according to the maximum number of PSFCH transmissions set for each CC. The maximum number of PSFCH transmissions for each CC may be set dynamically. In this case, signaling overhead in a UE capability reporting procedure may increase. The terminal may perform power control considering the maximum number of PSFCH transmissions for each CC. If a sum of PSFCH transmissions in all CCs exceeds the maximum number of PSFCH transmissions for a band (e.g. a band to which all CCs belong), the terminal may sequentially abandon (e.g. drop) PSFCH transmissions with low priority considering priorities of PSFCH transmissions in all CCs within a range of the maximum number of PSFCH transmissions for the band. As another method, the terminal may identify a PSFCH transmission with the lowest priority in each of the CCs, compare priorities of the PSFCH transmissions with the lowest priority in the CCs, and abandon (e.g. drop) all or some PSFCH transmissions belonging to a CC including a PSFCH transmission with the lowest priority.

### PSFCH Transmission and SL Retransmission

SL communication may be performed in the unicast, groupcast, or broadcast scheme. The receiving terminal may transmit HARQ feedback information (e.g. ACK or NACK) for SL unicast transmission on a PSFCH. The receiving terminal may transmit HARQ feedback information (e.g. ACK or NACK) for SL groupcast transmission on a PSFCH. In the SL CA environment, a terminal (e.g. receiving terminal) may perform PSFCH transmission in each of CCs in the same manner as in the single CC environment. If SL data is received in CC #0, the terminal may transmit HARQ feedback for the SL data in CC #0 (e.g. PSFCH within CC #0). In other words, transmission and reception of the SL data and transmission and reception of HARQ feedback for the SL data may be performed in the same CC.

The transmitting terminal transmitting the SL data may receive the HARQ feedback information of the receiving terminal on a PSFCH. The transmitting terminal may determine whether to retransmit the SL data based on the HARQ feedback information. When the HARQ feedback information indicates NACK, the transmitting terminal may perform a retransmission procedure for the SL data. The retransmission procedure for the SL data may be performed in a CC where the previous transmission procedure for the SL data was performed. In other words, the previous transmission procedure (e.g. initial transmission procedure) and retransmission procedure of the SL data may be performed in the same CC. If the initial transmission of the SL data is performed in CC #0, the transmitting terminal may retransmit the SL data in CC #0.

### PSFCH TX/RX Prioritization

PSFCH transmission operation(s) and PSFCH reception operation(s) may occur simultaneously in a plurality of CCs. In this case, the terminal may compare priorities of all PSFCH transmission operations and all PSFCH reception operations in the plurality of CCs. The terminal may perform an operation (e.g. PSFCH transmission operation or PSFCH reception operation) with the highest priority. For example, the terminal may identify a PSFCH transmission with the highest priority among all PSFCH transmissions, and may identify a PSFCH reception with the highest priority among all PSFCH receptions. The priority may be determined based on a priority value. The smaller the priority value, the higher the priority may be. The larger the priority value, the lower the priority may be.

If the highest priority of the PSFCH transmissions is higher than the highest priority of the PSFCH receptions, the terminal may perform PSFCH transmission operations in a plurality of CCs (e.g. all CCs). The PSFCH transmission operations may be performed at the time of (or after) comparing the priorities. If the highest priority of the PSFCH receptions is higher than the highest priority of the PSFCH transmissions, the terminal may perform PSFCH reception operations in a plurality of CCs (e.g. all CCs). The PSFCH reception operations may be performed at the time of (or after) comparing the priorities.

If the priority of the PSFCH transmission operations and the priority of the PSFCH reception operations are the same, the terminal may arbitrarily select one of the two operations. The terminal may arbitrarily select one operation (e.g. PSFCH transmission operations or PSFCH reception operations) in terms of implementation. If the priority of the PSFCH transmission operations and the priority of the PSFCH reception operations are the same, the terminal may compare a priority next to the highest priority of the PSFCH transmissions with a priority next to the highest priority of the PSFCH receptions, and may perform PSFCH transmission operations or PSFCH reception operations based on a result of comparing the priorities.

As another method, the terminal may compare a priority of a PSFCH transmission operation and a priority of a PSFCH reception operation in each of the CCs, compare priorities of PSFCH transmission operations and PSFCH reception operations between CCs, select a final operation based on a result of the comparison, and perform the selected final operation (e.g. PSFCH transmission operation or PSFCH reception operation). For example, if a PSFCH transmission has the highest priority in each of the CCs, the terminal may perform PSFCH transmission operations in all CCs. If a PSFCH reception has the highest priority in each of the CCs, the terminal may perform PSFCH reception operations in all CCs. If the priority of the PSFCH transmission operation and the priority of the PSFCH reception operation are the same, the terminal may arbitrarily select one of the two operations. In terms of implementation, the terminal may arbitrarily select one operation (e.g. PSFCH transmission operation or PSFCH reception operation). If the priority of the PSFCH transmission operations and the priority of the PSFCH reception operations are the same, the terminal may compare a priority next to the highest priority of the PSFCH transmissions with a priority next to the highest priority of the PSFCH receptions, and may perform PSFCH transmission operations or PSFCH reception operations based on a result of comparing the priorities.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a first terminal, comprising:
aligning sidelink (SL) resources in a first component carrier (CC) and a second CC; and
performing SL communication with a second terminal using the SL resources aligned within the first CC and the second CC.

2. The method according to claim 1, wherein the SL resources include at least one of a start symbol for the SL communication, a length of resource for the SL communication, a length of a cyclic prefix (CP), a physical sidelink feedback channel (PSFCH) periodicity, or a sidelink (S)-synchronization signal block (SSB) periodicity.

3. The method according to claim 1, further comprising: receiving SL resource configuration information from a base station, wherein the SL resources are aligned in the first CC and the second CC based on the SL resource configuration information.

4. The method according to claim 1, further comprising: transmitting SL resource configuration information used for alignment of the SL resources to the second terminal.

5. The method according to claim 1, wherein the performing of the SL communication includes: transmitting an S-SSB in a synchronization(S)-CC among the first CC and the second CC, wherein the S-SSB is not transmitted in a remaining CC excluding the S-CC among the first CC and the second CC, and synchronization in the S-CC and the remaining CC is acquired based on the S-SSB.

6. The method according to claim 5, wherein the S-CC is indicated by signaling of a base station, the S-CC is configured as a CC with a lowest index or a highest index among the first CC and the second CC, or the S-CC is configured as a CC in which an S-SSB associated with a synchronization reference with a highest priority among the first CC and the second CC is transmitted.

7. The method according to claim 1, wherein the performing of the SL communication includes:
performing initial transmission of SL data in one CC among the first CC and the second CC; and
receiving hybrid automatic repeat request (HARQ) feedback information for the SL data from the second terminal in the one CC,
wherein the initial transmission and reception of the HARQ feedback information are performed in a same CC.

8. The method according to claim 7, wherein the performing of the SL communication includes:
in response to the HARQ feedback information indicating a negative acknowledgment (NACK), performing retransmission of the SL data in the one CC,
wherein the initial transmission, reception of the HARQ feedback information, and the retransmission are performed in a same CC.

9. The method according to claim 1, wherein the SL communication includes PSFCH transmission, and a number of PSFCH transmissions performed in the first CC and the second CC is determined considering at least one of a maximum transmission power or a maximum number of the PSFCH transmissions.

10. The method according to claim 1, wherein the performing of the SL communication includes:
when an SL transmission operation occurs in the first CC and an SL reception operation occurs in the second CC or when an SL transmission operation and an SL reception operation occur in one CC among the first CC and the second CC, selecting one operation among the SL transmission operation and the SL reception operation based on priorities; and
performing the selected one operation.

11. A first terminal comprising at least one processor,
wherein the at least one processor causes the first terminal to perform:
aligning sidelink (SL) resources in a first component carrier (CC) and a second CC; and
performing SL communication with a second terminal using the SL resources aligned within the first CC and the second CC.

12. The first terminal according to claim 11, wherein the SL resources include at least one of a start symbol for the SL communication, a length of resource for the SL communication, a length of a cyclic prefix (CP), a physical sidelink feedback channel (PSFCH) periodicity, or a sidelink(S)-synchronization signal block (SSB) periodicity.

13. The first terminal according to claim 11, wherein the at least one processor further causes the first terminal to perform: receiving SL resource configuration information from a base station, wherein the SL resources are aligned in the first CC and the second CC based on the SL resource configuration information.

14. The first terminal according to claim 11, wherein the at least one processor further causes the first terminal to perform: transmitting SL resource configuration information used for alignment of the SL resources to the second terminal.

15. The first terminal according to claim 11, wherein in the performing of the SL communication, the at least one processor further causes the first terminal to perform: transmitting an S-SSB in a synchronization(S)-CC among the first CC and the second CC, wherein the S-SSB is not transmitted in a remaining CC excluding the S-CC among the first CC and the second CC, and synchronization in the S-CC and the remaining CC is acquired based on the S-SSB.

16. The first terminal according to claim 15, wherein the S-CC is indicated by signaling of a base station, the S-CC is configured as a CC with a lowest index or a highest index among the first CC and the second CC, or the S-CC is configured as a CC in which an S-SSB associated with a synchronization reference with a highest priority among the first CC and the second CC is transmitted.

17. The first terminal according to claim 11, wherein in the performing of the SL communication, the at least one processor further causes the first terminal to perform:
performing initial transmission of SL data in one CC among the first CC and the second CC; and
receiving hybrid automatic repeat request (HARQ) feedback information for the SL data from the second terminal in the one CC,
wherein the initial transmission and reception of the HARQ feedback information are performed in a same CC.

18. The first terminal according to claim 17, wherein in the performing of the SL communication, the at least one processor further causes the first terminal to perform: in response to the HARQ feedback information indicating a negative acknowledgment (NACK), performing retransmission of the SL data in the one CC, wherein the initial transmission, reception of the HARQ feedback information, and the retransmission are performed in a same CC.

19. The first terminal according to claim 11, wherein the SL communication includes PSFCH transmission, and a number of PSFCH transmissions performed in the first CC and the second CC is determined considering at least one of a maximum transmission power or a maximum number of the PSFCH transmissions.

20. The first terminal according to claim 11, wherein in the performing of the SL communication, the at least one processor further causes the first terminal to perform:
when an SL transmission operation occurs in the first CC and an SL reception operation occurs in the second CC or when an SL transmission operation and an SL reception operation occur in one CC among the first CC and the second CC, selecting one operation among the SL transmission operation and the SL reception operation based on priorities; and
performing the selected one operation.
